(19) United States
(12) Patent Application Publication
(10) Pub. No.: US 2025/0219068 A1
(43) Pub. Date: Jul. 3, 2025

(54) FREESTANDING LITHIUM-ALLOY ANODES FOR LITHIUM-SULFUR BATTERIES

(71) Applicant: Lyten, Inc., San Jose, CA (US)

(72) Inventors: Yunguang Zhu, Fremont, CA (US); Yongtao Meng, Santa Clara, CA (US)

(73) Assignee: Lyten, Inc., San Jose, CA (US)

(21) Appl. No.: 19/037,649

(22) Filed: Jan. 27, 2025

Related U.S. Application Data
(63) Continuation-in-part of application No. PCT/US2024/062163, filed on Dec. 27, 2024.
(60) Provisional application No. 63/664,639, filed on Jun. 26, 2024.
(60) Provisional application No. 63/658,087, filed on Jun. 10, 2024.
(60) Provisional application No. 63/616,995, filed on Jan. 2, 2024.
(60) Provisional application No. 63/616,412, filed on Dec. 29, 2023.
(60) Provisional application No. 63/616,427, filed on Dec. 29, 2023.

(51) Int. Cl. H01M 4/40; H01M 4/02; H01M 4/134; H01M 4/36; H01M 4/62; H01M 10/052; H01M 10/0569

(52) U.S. Cl. CPC H01M 4/405; H01M 4/134; H01M 4/364; H01M 4/366; H01M 4/623; H01M 4/625; H01M 10/052; H01M 10/0569; H01M 2004/021; H01M 2004/027; H01M 2300/0034

(57) ABSTRACT

Freestanding lithium-alloy anodes and fluorinated ether electrolytes for lithium-sulfur batteries. The freestanding lithium-alloy anode may include a dual-phase Li—Mg alloy phase and a Li₂Ca alloy phase. The freestanding lithium-alloy anode may include a composite Li—Mg alloy. The composite Li—Mg alloys may include one or more of a lithium-ion conducting material, an electron conducting material, or an ionic filler. The freestanding lithium alloy anodes may include at least one anode protective layer.

### RELATED APPLICATIONS

This Patent Application is a continuation-in-part application claiming priority to International Patent Application No. PCT/US2024/62163 entitled “Biphasic, ternary, and carbon-infused lithium-alloys and freestanding anodes for lithium-based batteries,” and filed on Dec. 27, 2024, which claims priority to U.S. Provisional Patent Application No. 63/664,639, entitled “Biphasic, three dimensional lithium-based alloys including ternary components and applications therefor,” and filed on Jun. 26, 2024, to U.S. Provisional Patent Application No. 63/658,087 entitled “Freestanding lithium-alloy anodes for lithium-based batteries,” and filed on Jun. 10, 2024, to U.S. Provisional Patent Application No. 63/616,995 entitled “Freestanding lithium-alloy anodes for lithium-based batteries,” and filed on Jan. 2, 2024, to U.S. Provisional Patent Application No. 63/616,412 entitled “Biphasic, three dimensional lithium-based alloys including ternary components and applications therefor,” and filed on Dec. 29, 2023, and to U.S. Provisional Patent Application No. 63/616,427 entitled “Graphitic carbon infused 3D anode composite materials and applications therefor,” and filed on Dec. 29, 2023, all of which are assigned to the assignee hereof. The disclosures of all prior Applications are considered part of and are incorporated by reference in this Patent Application in their respective entireties.

### TECHNICAL FIELD

This disclosure relates generally to batteries, and, more particularly, to lithium-sulfur batteries that can provide high specific energy and energy density combined with long cycle life.

### DESCRIPTION OF RELATED ART

Recent developments in batteries allow consumers to use high-specific energy batteries such as Li-sulfur batteries in many new applications. However, further improvements in battery technology are desirable.

### SUMMARY

This summary is provided to introduce in a simplified form a selection of concepts that are further described below in the Detailed Description section. This Summary is not intended to identify key features or essential features of the claimed subject matter, nor is it intended to limit the scope of the claimed subject matter.

In some implementations, a freestanding composite anode associated with a lithium-sulfur battery may include a lithium-magnesium (“Li—Mg”) alloy and one or more of a lithium-ion conducting material, an electron conducting material, or an ionic filler. In some aspects, the lithium-ion conducting material may include one of lithium titanate (“LTO”), lithium lanthanum zirconium oxide (“LLZO”), lithium nitride (Li₃N), or lithium phosphide (Li₃P). In some other aspects, the ionic filler may include one or more of alumina (Al₂O₃) or titanium dioxide (TiO₂). In some instances, an average particle size (d₅₀) of the ionic filler may be less than 50 nm. In some other instances, an average particle size (d₅₀) of the lithium ion conducting material may be between about 0.5 μm and about 2 μm.

In some implementations, the amount of the lithium-ion conducting material in the freestanding composite anode may be between approximately 10 wt % and approximately 40 wt %. In some instances, the amount of the ionic filler in the freestanding composite anode may be between approximately 10 wt % and approximately 40 wt %.

In some other instances, the Li—Mg alloy may include a 90 wt % Li-10 wt % Mg alloy. In some implementations, the magnesium content in the Li—Mg alloy in a freestanding composite anode may be between approximately 10 wt % and approximately 28 wt %.

In some implementations, the electron conducting material in a freestanding composite anode may include one or more of carbon, aluminum, or silicon. In some instances, carbon may include one or more of graphite, carbon nanotubes (“CNT”), carbon nano onions (“CNOs”), carbon nanofibers, or fullerenes. In some other instances, a carbon content may be between approximately 1 wt % and approximately 20 wt %.

In some implementations, a freestanding anode associated with a lithium-sulfur battery may include a lithium-magnesium ternary alloy (referred to herein as the “Li—X—Mg alloy”). In some other implementations, a freestanding composite anode associated with a lithium-sulfur battery may include a Li—Al—Mg ternary alloy. In some instances, an aluminum content in a Li—Al—Mg ternary alloy may be between approximately 5 wt % and approximately 20 wt %. In some instances, a Li—Al—Mg ternary alloy may further include any one of the lithium-ion conducting materials, electron conducting materials, or ionic fillers, previously described herein.

In some implementations, a freestanding composite anode associated with a lithium-sulfur battery may include a Li—Si—Mg ternary alloy. In some instances, a silicon content in a Li—Si—Mg ternary alloy may be between approximately 5 wt % and approximately 20 wt %. In some instances, a Li—Si—Mg ternary alloy may further include any one of the lithium-ion conducting materials, electron conducting materials, or ionic fillers, as previously described herein.

In some other implementations, a freestanding composite anode associated with a lithium-sulfur battery may include a Li—Mg/carbon alloy. In some instances, a carbon content in a Li—Mg/C alloy may be between approximately 1 wt % and approximately 20 wt %. In some instances, a Li—Mg/C alloy may further include any one of the lithium-ion conducting materials, or ionic fillers, as previously described herein.

In some implementations, a freestanding anode associated with a lithium-sulfur battery may include a dual-phase alloy including a Li—Mg alloy phase and a Li-x alloy phase. In some aspects, the Li-x alloy phase may include alloys of lithium and one of calcium, boron, tin, aluminum, indium, bismuth, antimony, or zinc. In some other aspects, the Li-x alloy phase may include a Li₂Ca (also referred to herein as CaLi₂) alloy phase. In some instances, the weight ratio of the Li—Mg alloy phase to the Li₂Ca alloy phase may be between approximately 0.1 and approximately 20.

In some implementations, a dual-phase alloy including a Li—Mg alloy phase and a Li₂Ca alloy phase may be characterized by a lithium content of between approximately 55 wt % and approximately 75 wt %, a magnesium content of between approximately 15 wt % and approximately 30 wt % and a calcium content of between approximately 2 wt % and approximately 30 wt %.

In some implementations, any one of the freestanding anodes described herein may include a polymer coating including one or more of polyvinylidene fluoride (“PVDF”), pentaerythritol tetraacrylate (“PETEA”) or polyethylene glycol dimethacrylate (“PEGDMA”) disposed on the freestanding anode. The thickness of the freestanding anode may be approximately 100 μm. The thickness of the polymer coating may be between approximately 1 μm and approximately 10 μm.

In some implementations, a lithium-sulfur battery may include any one of the freestanding anodes disclosed herein and a fluorinated ether electrolyte including approximately 50:25:25 (vol %) 1,2-dimethoxyethane (“DME”): 1,3-dioxolane (“DOL”): bis (2,2,2-trifluoroethyl) ether (“BTFE”) and including approximately 0.4 M lithium bis (trifluoromethanesulfonyl) (LiTFSI) and approximately 2 wt % LiNO₃. In some instances, a freestanding anode associated with a lithium-sulfur battery may include a freestanding composite anode including a Li—Mg alloy and one or more of a lithium-ion conducting material, an electron conducting material, or an ionic filler.

In some implementations, the fluorinated ether electrolyte in a Li—S battery including any one of the freestanding anodes described herein may include approximately 50:25:25 (vol %) DME: DOL: 1,1,2,2-tetraethoxyethane (“TEE”) and including approximately 0.4 M LiTFSI and approximately 2 wt % LiNO₃.

In some implementations, the fluorinated electrolyte in a Li—S battery including any one of the freestanding anodes described herein may include approximately 50:25:25 (vol %) DME: DOL: 1,1,2,2-tetrafluoroethyl 2,2,2-trifluoroethyl ether (“TFETFE”) and including approximately 0.4 M LiTFSI and approximately 2 wt % LiNO₃.

In some implementations, the fluorinated electrolyte in a Li—S battery including any one of the freestanding anodes described herein may include approximately 60:20:10:10 (vol %) DME: DOL: TEE: TFETFE and including approximately 0.4 M LiTFSI and approximately 2 wt % LiNO₃.

In some implementations, the fluorinated electrolyte in a Li—S battery including any one of the freestanding anodes described herein may include approximately 50:25:25 (vol %) DME: DOL: 1,1,2,2-tetrafluoroethyl-2,2,3,3-tetrafluoropropyl ether (“TTE”) and including approximately 0.4M LiTFSI and approximately 2 wt % LiNO₃.

In some implementations, the fluorinated electrolyte in a Li—S battery including any one of the freestanding anodes described herein may include approximately 50:25:25 (vol %) DME: DOL: 1 fluorinated 1,4-dimethoxylbutane (“FDMB”) including approximately 0.4 M LiTFSI and approximately 2 wt % LiNO₃.

In some implementations, the fluorinated electrolyte in a Li—S battery including any one of the freestanding anodes described herein may include approximately 1.0 M LiTFSI in approximately 50:50 (vol %) DOL: BTFE.

In some implementations, the fluorinated electrolyte in a Li—S battery including any one of the anodes described herein may include approximately 50:25:25 (vol %) DME: DOL: BTFE, and including between approximately 0.6 M and approximately 0.8M LiTFSI, between approximately 0.5M and approximately 0.7M LiNO₃, and between approximately 0.15M and approximately 0.2M dicyandiamide (“DCDA”).

In some implementations, an example lithium-sulfur battery may include a cathode disposed opposite to any one of the freestanding anodes described herein. In some implementations, an example cathode may include one or more porous carbon layers including porous carbon agglomerates of porous carbon primary nanoparticles, wherein a respective porous carbon primary nanoparticle may include an inner porous shell disposed about a center of the respective porous carbon primary nanoparticle and enclosing an inner porous carbon region, an outer porous shell enclosing an outer porous carbon region disposed between the inner shell and the outer shell, and an interconnected porous network disposed in and in fluid communication with the inner and outer porous carbon regions.

In some aspects, the inner carbon region and the outer carbon region of example porous carbon primary nanoparticles may be characterized by an average pore size and an average pore density associated with each region. In some other aspects, the average pore size may decrease along a radial direction from the center to the outer porous shell.

In some instances, an example porous carbon primary nanoparticle may further include one or more intermediate porous shells disposed between the inner porous shell and the outer porous shell, wherein each of the intermediate porous shells encloses a respective intermediate porous carbon region.

In some aspects, the porous carbon agglomerates may be characterized by a Raman spectroscopy signature with an ID/IG ratio between approximately 0.95 and approximately 1.05. In some other aspects, the porous carbon agglomerates may be characterized by a Brunauer-Emmett-Teller (“BET”) surface area between approximately 50 m²/g and 300 m²/g measured using nitrogen gas. In some aspects, the porous carbon agglomerates may be characterized by an electrical conductivity of between approximately 500 S/m and 20,000 S/m when compressed at a pressure of approximately 12,000 pounds per square inch (psi).

In some implementations, an example cathode associated with a lithium-sulfur battery may include porous carbon agglomerates of porous carbon primary nanoparticles, which include one or more interconnected bundles of electrically conductive graphene layers. In some aspects, the graphene layers may be arranged as one or more stacks connected to each other and defining a 3D porous scaffold structure including mesopores. In some other aspects, the one or more stacks may be disposed substantially orthogonal to each other. In some instances, the graphene layers may be characterized by a linear dimension of between approximately 50 nm and approximately 200 nm. In some other instances, the graphene layers may include one or more of single layer graphene (“SLG”), few layer graphene (“FLG”), or many layer graphene (“MLG”). In some aspects, the porous carbon agglomerates may be characterized by an electrical conductivity of between approximately 500 S/m and 20,000 S/m when compressed at a pressure of approximately 12,000 pounds per square inch (psi).

In some implementations, the geometrical shape of any one of the Li—S batteries previously described may be cylindrical. The cylindrical battery may be approximately 18 mm in diameter and approximately 65 mm in length. In some implementations, the cylindrical battery may be approximately 21 mm in diameter and approximately 70 mm in length. In some implementations, the cylindrical battery may be approximately 46 mm in diameter and approximately 80 mm in length.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a plot illustrating cathode discharge capacity of example lithium-sulfur coin cells including freestanding Li—Mg alloy anodes of varying Li—Mg compositions, according to some implementations.

FIG. 2A shows an example X-ray diffraction (XRD) pattern of a dual-phase freestanding anode alloy including a Li—Mg alloy phase and a Li₂Ca alloy phase, according to some implementations.

FIG. 2B shows a scanning electron microscopy (SEM) micrograph of a cross section of an example dual-phase freestanding anode alloy including a Li—Mg alloy phase and a Li₂Ca alloy phase, according to some implementations.

FIG. 2C shows another SEM micrograph of an example dual-phase freestanding anode alloy including a Li—Mg alloy phase and a Li₂Ca alloy phase, according to some implementations.

FIG. 3A shows a scanning electron microscopy (SEM) micrograph of a cross section of an example dual-phase freestanding anode alloy including a Li—Mg alloy phase and a Li₂Ca alloy phase, according to some implementations.

FIGS. 3B-3C show SEM-energy dispersive X-ray spectroscopy (EDS) elemental dispersion images of an example dual-phase freestanding anode alloy including a Li—Mg alloy phase and a Li₂Ca alloy phase, according to some implementations.

FIG. 4A shows voltage profiles of example lithium-sulfur half cells including a freestanding composite anode including a Li—Mg alloy and lithium titanate (“LTO”), according to some implementations.

FIGS. 4B-4C show SEM images and SEM-EDS elemental dispersion images of an example Li—Mg alloy anode and a freestanding composite anode including Li—Mg alloy/LTO, respectively, according to some implementations.

FIG. 5A shows a schematic diagram of an example porous carbon primary nanoparticle, according to some implementations.

FIG. 5B shows a transmission electron microscopy (TEM) image showing aggregates of porous carbon primary nanoparticles, according to some implementations.

FIG. 5C shows a TEM image of agglomerates of porous carbon primary nanoparticles, according to some implementations.

FIG. 5D shows a TEM image of surface etched agglomerates of porous carbon primary nanoparticles, according to some implementations.

FIG. 5E shows a schematic diagram of another example porous carbon primary nanoparticle, according to some implementations.

FIG. 6A shows a schematic diagram of agglomerates of porous carbon primary nanoparticles, according to some implementations.

FIG. 6B shows a scanning electron microscopy (SEM) micrograph of agglomerates of porous carbon primary nanoparticles, according to some implementations.

FIG. 6C shows a TEM micrograph of agglomerates of porous carbon primary nanoparticles, according to some implementations.

FIG. 7 shows a schematic diagram depicting an example lithium-sulfur cylindrical battery, according to some implementations.

FIG. 8A shows a plot illustrating cathode discharge capacity of lithium-sulfur coin cells including dual-phase freestanding anodes including a Li—Mg alloy phase and a Li₂Ca alloy phase, according to some implementations.

FIG. 8B shows another plot illustrating cathode discharge capacity of lithium-sulfur coin cells including dual-phase freestanding anodes including a Li—Mg alloy phase and a Li₂Ca alloy phase, according to some implementations.

FIG. 9A shows a plot illustrating the rate capability test performance of lithium-sulfur symmetric cells including a freestanding composite anode including a Li—Mg alloy and LTO, according to some implementations.

FIG. 9B shows a plot illustrating corrosion current after lithium stripping measured using lithium-sulfur symmetric cells including a freestanding composite anode including a Li—Mg alloy and LTO, according to some implementations.

FIG. 9C shows a plot illustrating corrosion current after lithium plating measured using lithium-sulfur symmetric cells including a freestanding composite anode including a Li—Mg alloy and LTO, according to some implementations.

FIG. 10 shows a plot illustrating cathode discharge capacity of lithium-sulfur coin cells including a freestanding composite anode including a Li—Mg alloy and LTO, according to some implementations.

FIGS. 11A-11B show plots illustrating cathode discharge capacity and capacity retention of lithium-sulfur coin cells including a freestanding Li—Al—Mg ternary alloy anode, according to some implementations.

FIGS. 12A-12B show plots illustrating cathode discharge capacity and capacity retention of lithium-sulfur coin cells including a freestanding Li—Si—Mg ternary alloy anode, according to some implementations.

FIGS. 13A-13C show plots illustrating cathode discharge capacity, capacity retention, and polarization of lithium-sulfur coin cells including a freestanding Li—Mg/C alloy anode, according to some implementations.

FIG. 14 shows a plot illustrating early cycling cathode discharge capacity of lithium-sulfur coin cells including lithium-magnesium alloy composite anodes, according to some implementations.

FIGS. 15A-15B show plots illustrating discharge capacity and capacity retention, respectively, of lithium-sulfur pouch cells including lithium-magnesium alloy composite anodes, according to some implementations.

Like reference numbers and designations in the various drawings indicate like elements.

### DETAILED DESCRIPTION

The following description is directed to some example implementations for the purpose of describing the innovative aspects of this disclosure. However, a person having ordinary skill in the art will readily recognize that the teachings herein can be applied in a multitude of different ways. The implementations described can be implemented in batteries for a variety of applications and may be tailored to compensate for various performance related deficiencies. As such, the disclosed implementations are not to be limited by the examples provided herein, but rather encompass all implementations contemplated by the attached claims. Additionally, well-known elements of the disclosure will not be described in detail or will be omitted so as not to obscure the relevant details of the disclosure.

Various aspects of the novel compositions and methods are described more fully herein with reference to the accompanying drawings. These aspects are provided so that this disclosure will be thorough and complete, and will fully convey the scope of the disclosure to those skilled in the art. Although some examples and aspects are described herein, many variations and permutations of these examples fall within the scope of the disclosure. Although some benefits and advantages of the various aspects are mentioned, the scope of the disclosure is not intended to be limited to benefits, uses, or objectives. The detailed description and drawings are merely illustrative of the disclosure rather than limiting, the scope of the disclosure being defined by the appended claims and equivalents thereof.

In this disclosure, a primary carbon nanoparticle may be considered as a spheroidal shaped, non-discreet component or building block of an aggregate, separable from the aggregate only by fracturing. A plurality of primary carbon nanoparticles produced by one or more methods including thermal cracking of a hydrocarbon gas, may be coalesced, or joined to form aggregates of primary carbon nanoparticles. A carbon aggregate may be considered as a discrete, colloidal entity that is the smallest dispersible unit, composed of coalesced primary carbon nanoparticles. The primary carbon nanoparticles may be connected together by one or more of van der Waals forces, covalent bonds, ionic bonds, metallic bonds, or by other physical or chemical interactions. A plurality of aggregates may be considered as an agglomerate. Agglomerates of primary carbon nanoparticles may be produced from one or more methods including thermal cracking of a hydrocarbon gas. An example porous carbon agglomerate of primary carbon nanoparticles may be characterized by a principal dimension of at least approximately 1 μm.

In this disclosure, “graphene” refers to an allotrope of carbon in the form of atomic-scale, hexagonal lattice in which one atom forms each vertex. The carbon atoms in graphene may be sp² hybridized carbon atoms. Additionally, graphene has a Raman spectrum with two main peaks: a G-mode at approximately 1580 cm⁻¹ and a D mode at approximately 1350 cm⁻¹ (when using a 532 nm excitation laser). As used herein, carbonaceous materials may refer to materials containing or formed of one or more types or configuration of carbon.

Commercialization of lithium-sulfur (“Li—S”) batteries has been hampered by limited discharge/charge cycling of less than approximately 100 cycles. Root cause analysis suggests that Li-metal anode failure is a primary reason for cell failure. During cycling, the Li-metal anode experiences significant volume change caused by repeated stripping (during discharge) and plating (during charge) of lithium. This volume change negatively impacts anode stability, and in particular, the stability of unsupported (or freestanding) Li-metal anodes. In a freestanding Li-metal anode, the anode is not supported on a metal substrate such as a copper current collector. Anode stability is further impacted by an unstable electrode-electrolyte interface and pulverization of the anode caused by volume changes during cycling, because lithium has a high oxidation potential (approximately 3.04V) and can react with almost any electrolyte solution, either in a solvent or in a salt form, to form a solid electrolyte interphase (“SEI”) layer.

The SEI layer is electronically insulating but ionically conductive to Li⁺ ions. As such, once the SEI layer is formed, additional undesirable reaction between the Li-metal anode and electrolyte may be blocked or partially blocked by the SEI layer. However, the SEI layer is generally non-uniform, which results in non-uniform current distribution during plating, and may cause uneven (or non-uniform) lithium deposition and anode cracking during cycling. Fresh lithium metal-anode may be exposed to the electrolyte resulting in the undesirable consumption of lithium for re-formation of the SEI layer. The localized non-uniform lithium deposition and stripping may manifest as dendrites during plating and pits during stripping at the anode during charge/discharge cycles. Dendrites may cause serious safety problems and reduce the cyclability of lithium-ion batteries. Additionally, dendrites may be dislodged from the anode to form ‘dead’ zones of lithium. Lithium dendrites may penetrate through polyolefin separators or even polymer/solid electrolyte separators disposed between the anode and the cathode of a battery and negatively impact the safety and performance of Li-ion batteries.

The above problems are further exacerbated in Li—S batteries, which include sulfur confined in a porous carbon cathode as the active cathode material. Sulfur reacts with lithium ions forming polysulfides. During the discharge cycle, Li ions migrate from the anode to the cathode through the electrolyte where sulfur is reduced to lithium sulfide (Li₂S). The sulfur reduction to Li₂S is complex and may involve the formation of several intermediate Li polysulfides (Li₂Sₓ, 8<x<1). Polysulfides (“Li—PS”) may be formed during the battery discharge cycle as:

S₈→Li₂S₈→Li₂S₆→Li₂S₄→Li₂S₃→Li₂S₂→Li₂S

Ideally, the Li—PS compounds oxidize back to sulfur during the charge cycle. In practice, Li—PS compounds leak out from the porous carbon cathode as they are highly soluble in the electrolyte, which results in loss of sulfur and reduction in cathode capacity. While sulfur and Li₂S are relatively insoluble in most electrolytes, many intermediate polysulfides (“Li—PS”) are soluble and cause irreversible loss of active sulfur from the cathode. The dissolution of Li—PS in the electrolyte requires a large amount of electrolyte (E/S>3), which reduces battery specific energy. The higher polysulfides (Li₂S₈ and Li₂S₆) may diffuse to the anode and may get reduced to lower polysulfides (Li₂S₆ and Li₂S₄), which subsequently get oxidized at the cathode. At the anode, the polysulfides participate in SEI formation, increase the unevenness of SEI, and aggravate the corrosion of the Li metal anode. This cyclic process commonly known as the polysulfide “shuttle effect” results in poor coulombic efficiency, and progressive leakage of active sulfur material from the cathode which also reduces the life cycle of the battery. Further, the conversion of elemental sulfur to Li₂Sₓ sulfur compounds is accompanied by large volumetric expansion at the cathode (which could be as high as 80%), which subjects the cathode to significant mechanical stresses resulting in rapid cathode degradation.

Additionally, the “shuttle effect” is responsible for self-discharge of Li—S batteries, because of the slow dissolution of Li—PS during battery dormancy. Battery self-discharge reduces battery life and causes safety issues. The repeated volume change and the corrosion reactions at the anode continuously consume active Li and form massive “dead Li,” which may be detached during cycling, leading to poor recyclability of Li—S battery. As previously noted, often the anode contributes to cell failure, either via electrolyte consumption of Li due to corrosion or its depletion during cycling. These challenges limit the commercial viability of high-specific energy Li—S batteries having dense cathodes, limited electrolyte, and limited anode capacity (or low N/P ratio). The N/P ratio may be defined as the ratio of reversible capacity (mAh) of the negative electrode (anode) to that of the positive electrode (cathode) assuming complete utilization of sulfur.

Accordingly, to mitigate the loss of conductivity due to dissolved Li—PS an excess amount of electrolyte is used in Li—S batteries. Additionally, to mitigate lithium-metal loss due to SEI formation, pitting, and dendrite formation, an excess of lithium-metal is required at the anode. These requirements frustrate attempts to reach or exceed the specific energy target of 500 W-h/kg in Li—S batteries. Li—S batteries generally require an electrolyte to sulfur ratio (“E/S ratio”) of approximately 5 μL/mgS, and a N/P ratio of greater than 2. For comparison, the N/P ratio in commercial Li-ion batteries is between approximately 1.03 and 1.2. While the N/P ratio is important to offset the likely higher loss of anode material during cycling, the areal capacity (mAh/cm²) is also critical to reduce the current density and hence failure rate on the anode.

Li—S anodes generally use a current collector such as copper as an anode support. Copper adds significant weight to Li—S batteries and reduces the specific energy of the battery. Copper is also susceptible to corrosion by polysulfides. Accordingly, there is significant interest in developing substrate-free or freestanding anodes. However, freestanding anode in Li—S batteries is challenging due to the morphological and instability issues with the lithium-metal (100% lithium) anode. Freestanding anode alloy compositions that are stable under cyclic conditions in Li—S batteries and at low E/S ratios of approximately less than or equal to 5 for coin cells, and less than or equal to 3 for pouch cells are needed. Freestanding anode compositions that are stable under cyclic conditions in Li—S batteries and at N/P ratios of approximately less than 2 to realize battery specific energy of 500 W-h/kg are also needed.

In some implementations, Li-alloys may be used as freestanding anodes instead of pure-lithium metal anodes to overcome the previously described anode instability issues related to volume change during cycling, and the high reactivity of the Li-metal anodes with the electrolyte and with polysulfides. Lithium may alloy with several metals including one or more of silicon, tin, magnesium, or aluminum. Li-alloy anodes may be characterized by higher electrode potential compared to lithium and may hinder corrosion at the anode caused by reactions between the anode and polysulfides and electrolytes. Meanwhile, the alloying element may function as a lithium host for lithium deposition or plating (during the charge cycle) absorb volume changes during cycling and help to stabilize the anode. The alloying element may form a stable surface film over the anode, which may reduce the non-uniform deposition of lithium during plating.

Some alloying elements with lithium may reduce the capacity of Li—S batteries and subsequently reduce battery specific energy (W-h/kg). Additionally, some alloying elements, for example, silicon (Si), tin (Sn), and germanium (Ge), may undergo severe volume changes during lithiation (plating, during charge cycle) and de-lithiation (stripping during discharge) and may not be suitable candidates for a Li—S battery anode. With elements such as silicon and tin, lithium may form intermetallic compounds of the type LiₓM_{y}, which have a high degree of ionic bonding, and as such, are brittle, and fragile. Some other lithium alloys such as lithium-aluminum alloys are reversible only over a limited composition range and may not be suitable for Li—S battery use.

In some implementations, alloying lithium with small amounts of magnesium (Mg) may improve the stability of Li—S battery anodes to reactions with the electrolyte and polysulfides and increase battery cycle life. In lithium-magnesium (“Li—Mg”) alloy anodes, the magnesium alloying element may provide structural integrity to the anode during volume changes associated with battery cycling, because magnesium does not undergo stripping and plating at the anode. Additionally, alloying lithium with small amounts of magnesium permits a free-standing anode design (without the need for a copper current collector substrate), which also increases battery specific energy.

Li and Mg have comparable atomic radii and form an extended single solid phase (body centered cubic structure or BCC) alloy over a wide composition range of approximately 11.5-100 wt % lithium in Li—Mg alloys. Therefore, the capacity of a Li—Mg alloy anode may be tuned over a broad range free of any alloy phase change considerations. The Li—Mg alloy may provide a scaffold-like structure, which may facilitate insertion and removal of Li⁺ ions during the charge/discharge cycling of a Li—S battery. The volume change related to the insertion of one mole of Li into Mg may be approximately 80% as calculated using Li—Mg alloy lattice parameters, which is much lower than the volume change related to the interaction of lithium with other alloying elements such as silicon, tin, and antimony. Li—Mg alloys are very ductile, which permit straightforward fabrication of electrodes by rolling and annealing. At Li-rich compositions of approximately 90%, no loss in battery voltage may be observed when replacing a Li-anode (100% lithium) with a Li—Mg anode, because lithium stripping and plating may occur close to 0 V. Additionally, as magnesium is lithiophilic, dispersed magnesium in Li—Mg anodes may serve as nucleation sites for uniform lithium deposition during the charge cycle.

Since Li—Mg alloy anodes form relatively stable SEI interface (compared to Li-anodes), a comparatively smooth anode surface morphology may be realized during the cyclic operation of a Li—S battery. Additionally, a Li—Mg alloy matrix, poor in lithium, and with high electric and ionic conductivity, may be formed after Li stripping to provide an excellent anode current collector and host for subsequent Li plating. Accordingly, Li—Mg alloy anodes may be freestanding and may not require a separate anode current collector.

As previously described, lithium has a high oxidation potential (of approximately 3.04V) and can react with almost any electrolyte solution, either in a solvent or in a salt form, to form a solid electrolyte interphase (“SEI”) layer. Lithium anode stability is further impacted by an unstable electrode-electrolyte interface and pulverization of the anode caused by volume changes during cycling. Alloying lithium with metals including magnesium may reduce the life of the anode in lithium-sulfur cells, but this increased stability often requires an increase in the number of formation cycles required to reach a target cathode discharge capacity.

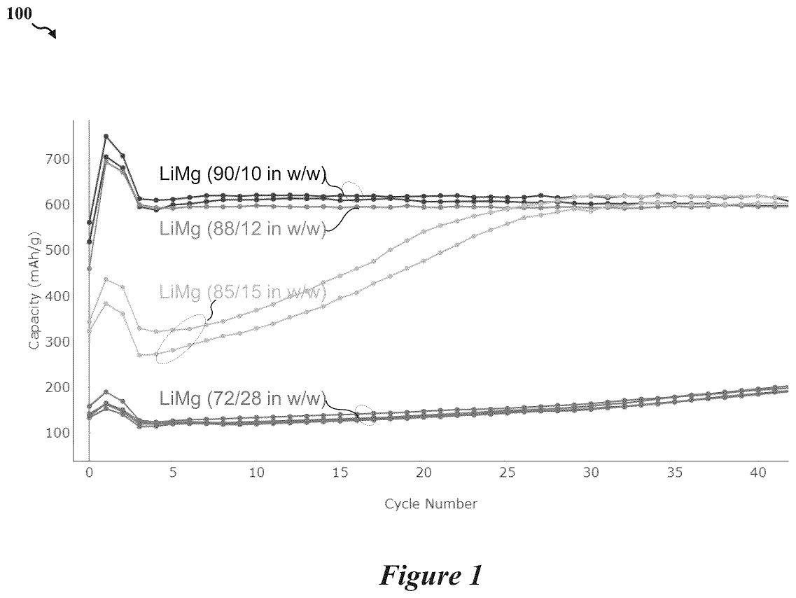

FIG. 1 shows a plot 100 illustrating cathode discharge capacity of example lithium-sulfur coin cells including freestanding Li—Mg alloy anodes of varying Li—Mg compositions, according to some implementations. Tests were conducted at C/3 charge/discharge rate after initial formation (also referred to herein as activation) cycles at a C/20 rate for 2 cycles followed by a C/10 rate for 1 cycle. The Mg content in the Li—Mg alloys was between approximately 10 wt % and approximately 28 wt %. The thickness of the Li—Mg freestanding alloy anodes was approximately 100 μm. The cathode loading was approximately 7.5 mg/cm². The cathode capacity in each case was approximately 4 mAh/cm². A Celgard PP2075 separator was disposed between the cathode and anode. The anodes did not include any polymeric material coating. The electrolyte included approximately 50:25:25 (vol %) 1,2-dimethoxyethane (“DME”): 1,3-dioxolane (“DOL”): bis (2,2,2-trifluoroethyl) ether (“BTFE”) and including approximately 0.4 M lithium bis (trifluoromethanesulfonyl) imide (“LiTFSI”) and approximately 2 wt % LiNO₃. The electrolyte-to-sulfur (“E/S”) ratio was approximately 5.

Referring to FIG. 1, initial cathode discharge capacity at C/20 rate decreased as the Mg content in the Li—Mg alloy anodes increased beyond 12 wt %. With the 72 Li-28 Mg alloy anode (72 wt % Li and 28 wt % Mg), initial discharge capacity measured was less than 200 mAh/g, which is a 3× decrease in initial discharge capacity over the discharge capacity measured using the 90 Li-10 Mg alloy anode. With repeated formation cycles, the cells including the 85 Li-15 Mg alloy anode produced a discharge capacity comparable to that of the 90 Li-10 Mg anode. This extended formation cycling including approximately 25 cycles is not practical for several applications. Prolonged formation cycling through 40 cycles of cells including 72 Li-28 Mg alloy anode did not significantly increase the discharge capacity. As such, increased anode stability in Li—Mg alloy anodes may be realized at the expense of discharge capacity and formation cycling time. There is a need to realize improved anode stability with high discharge capacity of approximately 600 mAh/g and at formation cycles of less than approximately 5.

In some implementations, a freestanding anode associated with a lithium-sulfur battery may include a dual-phase alloy including a Li—Mg alloy phase and a Li-x alloy phase. In some aspects, the Li-x alloy phase may include alloys of lithium and one of calcium, boron, tin, aluminum, indium, bismuth, antimony, or zinc. In some other aspects, the Li-x alloy phase may include a Li₂Ca (also referred to herein as CaLi₂) alloy phase. In some instances, the weight ratio of the Li—Mg alloy phase to the Li₂Ca alloy phase may be between approximately 0.1 and approximately 20.

In some implementations, a dual-phase alloy including a Li—Mg alloy phase and a Li₂Ca alloy phase may include a lithium content of between approximately 55 wt % and approximately 75 wt %, a magnesium content of between approximately 15 wt % and approximately 30 wt % and a calcium content of between approximately 2 wt % and approximately 30 wt %. Cathode discharge capacity of example lithium-sulfur coin cells including a freestanding dual phase alloy anode including a Li—Mg alloy phase and a Li₂ Ca alloy is discussed below under Example 1.

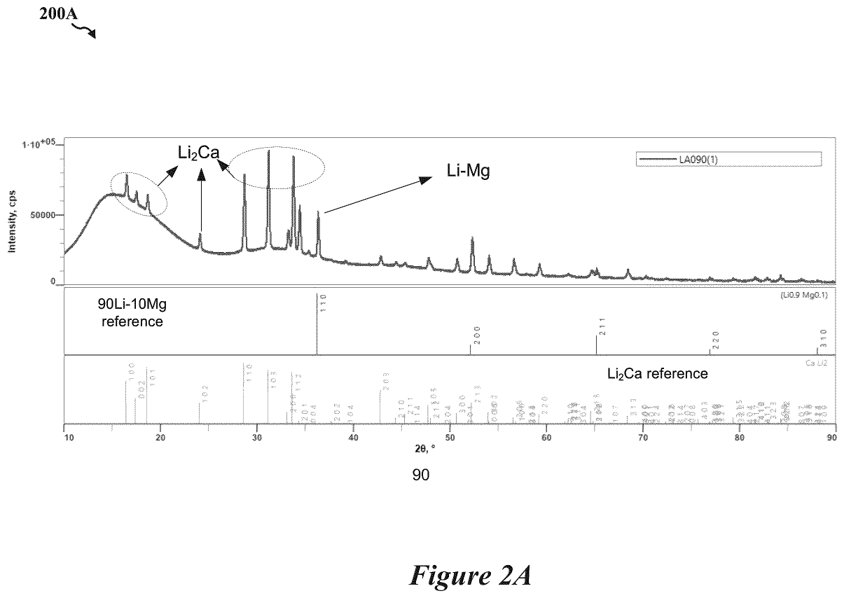

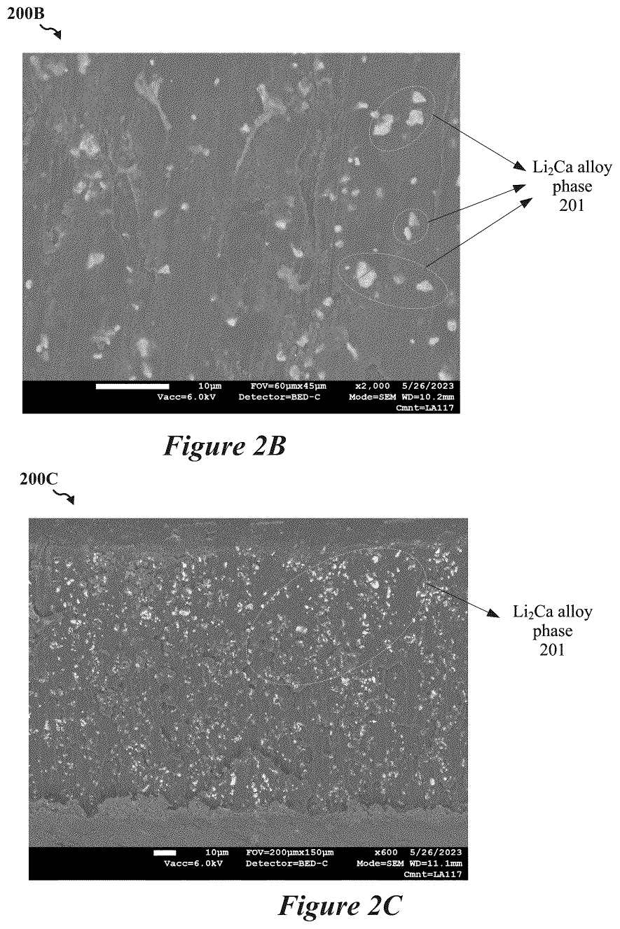

FIG. 2A shows an example X-ray diffraction (“XRD”) pattern 200A of a dual-phase freestanding anode alloy including a Li—Mg alloy phase and a Li₂Ca alloy phase, according to some implementations. The elemental composition of the example dual-phase anode alloy was approximately 55 wt % Li, approximately 17 wt % Mg and approximately 28 wt % Ca. As can be seen, the XRD pattern 200A confirms the presence of a Li—Mg alloy phase with a characteristic peak corresponding to the (110) plane based on the reference XRD fingerprint of the 90 wt % Li— 10 wt % Mg alloy (“90 Li-10 Mg” alloy). Additionally, the XRD pattern 200A confirms the presence of a Li₂Ca alloy phase with a fingerprint corresponding to the (100), (002), (101), (102), (110), (103), (200) and (112) planes based on the reference XRD fingerprint of the Li₂Ca alloy.

FIG. 2B shows a scanning electron microscopy (“SEM”) micrograph 200B of a cross section of an example dual-phase freestanding anode alloy including a Li—Mg alloy phase and a Li₂Ca alloy phase, according to some implementations. The elemental composition of the example dual-phase anode alloy was approximately 55 wt % Li, approximately 17 wt % Mg and approximately 28 wt % Ca. As can be seen, discrete Li₂Ca alloy 201 is dispersed in the Li—Mg alloy matrix.

FIG. 2C shows another SEM micrograph 200C of an example dual-phase freestanding anode alloy including a Li—Mg alloy phase and a Li₂Ca alloy phase, according to some implementations. SEM micrograph 200C was collected in the backscattered electron mode. As can be seen, Li₂Ca alloy 201 is uniformly dispersed in the Li—Mg alloy matrix. These observations corroborate the XRD pattern of a dual-phase alloy (referring to FIG. 2A) and confirms the presence of a dual alloy phase including a Li—Mg alloy phase and a Li₂Ca alloy phase in the example freestanding anode. Those skilled in the art will appreciate that the micrographs are shown by way of example only, and that other scales may exist without departing from the scope and spirit of the present implementations.

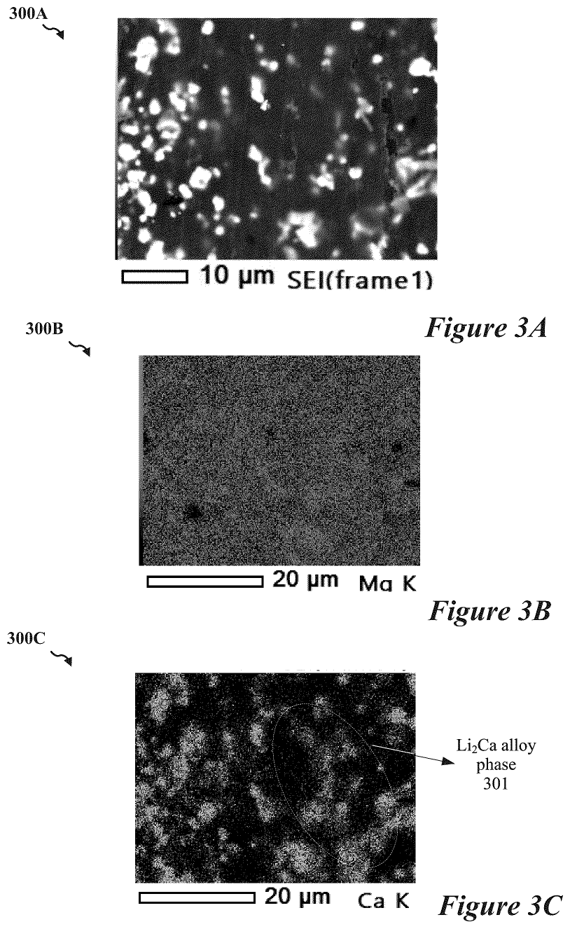

FIG. 3A shows a scanning electron microscopy (SEM) micrograph 300A of a cross section of an example dual-phase freestanding anode alloy including a Li—Mg alloy phase and a Li₂Ca alloy phase, according to some implementations. FIGS. 3B-3C show SEM-EDS elemental dispersion images 300B-300C of an example dual-phase freestanding anode including a Li—Mg alloy phase and a Li₂Ca alloy phase, according to some implementations. The elemental composition of the example dual-phase anode alloy was approximately 55 wt % Li, approximately 17 wt % Mg and approximately 28 wt % Ca. Similar to micrograph 200A (referring to FIG. 2A), micrograph 300A shows the dispersion of Li₂Ca alloy in the Li—Mg alloy matrix. The elements examined during EDS analysis included magnesium (shown in EDS image 300B, K line) and calcium (shown in elemental dispersion image 300C, K line). Referring to FIG. 3C, the discrete and substantially uniform distribution of calcium suggests no cross-contamination between the dual-phase alloys Li—Mg and Li₂Ca. Additionally, the dual-phase alloys were produced at approximately 300° C., which is much lower than the formation temperature of at least approximately 400° C. for a Mg—Ca alloy. As such, the above observations indicate that calcium is present as Li₂Ca alloy 301. The dual-phase alloy including Li—Mg alloy phase and a Li₂Ca alloy phase is also substantially free of any unalloyed calcium. The uniform distribution of Mg (referring to FIG. 3B) suggests that the Li₂Ca phase is distributed in the Li—Mg alloy phase in the dual phase anode alloy.

In some implementations, any of the dual-phase freestanding anode alloys previously disclosed herein may include a polymer coating including one or more of polyvinylidene fluoride (“PVDF”), pentaerythritol tetraacrylate (“PETEA”) or polyethylene glycol dimethacrylate (“PEGDMA”), or any combination thereof, disposed on the freestanding anode. The thickness of the coating layer may be between approximately 1 μm and approximately 10 μm.

In some other implementations, a lithium-sulfur battery target of high cathode discharge capacity (for example, approximately 600 mAh/g) may be realized without sacrificing anode stability and cell formation cycle time using a Li—Mg alloy composite anode. In some implementations, a freestanding composite anode associated with a lithium-sulfur battery may include a Li—Mg alloy and a lithium-ion conducting material. In some aspects, the lithium-ion conducting material may include one of lithium titanate (“LTO”), lithium lanthanum zirconium oxide (“LLZO”), lithium nitride (Li₃N), or lithium phosphide (Li₃P). In some other aspects, an example freestanding Li—Mg alloy composite anode may further include one of alumina (Al₂O₃) or titanium dioxide (TiO₂). In some instances, the amount of the lithium-ion conducting material in the freestanding Li—Mg alloy composite anode may be between approximately 10 wt % and approximately 40 wt %. In some other instances, the weight ratio of the Li—Mg alloy composite anode to the lithium-ion conducting material may be between approximately 1 and approximately 9. Cathode discharge capacity of example lithium-sulfur coin cells including a freestanding dual phase alloy anode including a Li—Mg alloy phase and a Li₂Ca alloy is discussed below under Example 3. Without being bound by any particular theory the lithium-ion conducting materials may help in controlling the grain size of Li—Mg in the Li—Mg alloy and facilitate lithium-ion diffusion across grain boundaries.

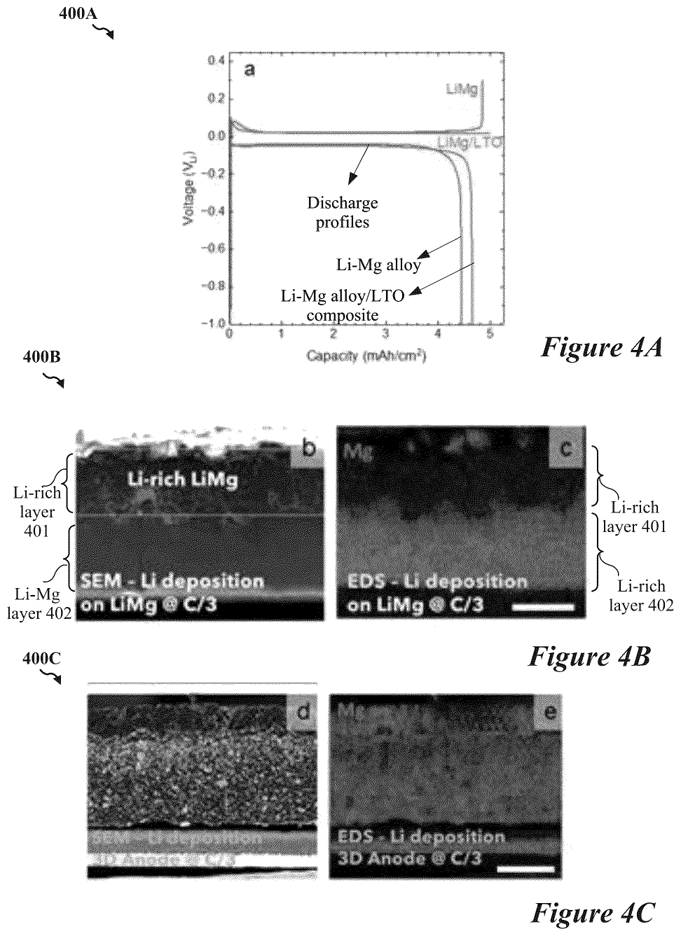

FIG. 4A shows voltage profiles 400A of example lithium-sulfur half cells including a freestanding composite anode including a Li—Mg alloy and lithium titanate (“LTO”), according to some implementations. The voltage profiles of the half cells with freestanding Li—Mg alloy anode and Li—Mg alloy/LTO composite anode were measured at charging current of 0.2 mA/cm² and discharge current of 1.3 mA/cm². A copper foil was used as the cathode. A glass fiber (GF/A) separator was used between the cathode and anode. The anode did not include any polymeric material coating. The electrolyte included approximately 50:25:25 (vol %) DME: DOL: BTFE and including approximately 0.4 M LiTFSI and approximately 2 wt % LiNO₃. As shown in FIG. 4A, with one discharge/charge cycle at C/3 rate, the charge/discharge profiles of the symmetric cell including the Li—Mg alloy/LTO composite anode was flatter than that measured using the Li—Mg alloy anode.

FIGS. 4B-4C show SEM images and SEM-EDS elemental dispersion images 400B-400C of an example Li—Mg alloy anode and freestanding composite anode including Li—Mg alloy/LTO, respectively, according to some implementations. The Li—Mg alloy anode sample and Li—Mg alloy/LTO composite anode sample corresponding to the tests associated with FIG. 4A were examined under SEM-EDS imaging. Referring to FIG. 4B, the Li—Mg alloy anode shows a Li-rich layer 401 disposed on a and a Li—Mg alloy layer 402. This stratified gradation in Li—Mg alloy composition could negatively impact anode stability. The EDS analysis targeted magnesium (K line). In contrast, referring to FIG. 4C, the Li—Mg alloy/LTO composite anode showed uniform Mg distribution suggesting stripping and plating of lithium. This result suggests that Li—Mg alloy/LTO composite anode could favor improved anode stability compared to the Li—Mg alloy anode.

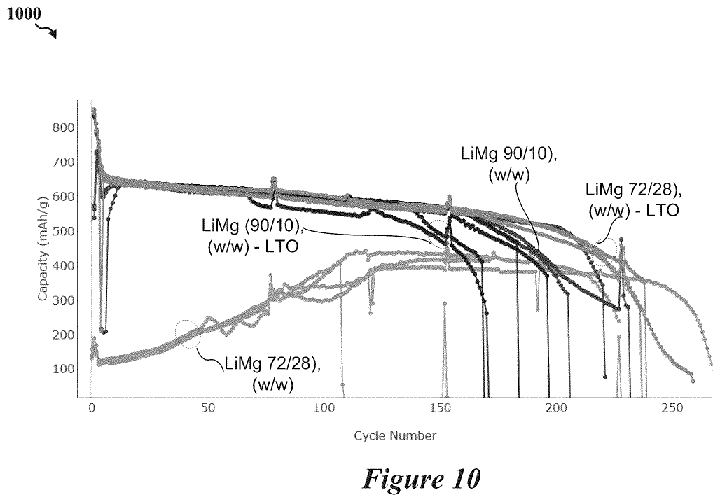

In some implementations, lithium-sulfur batteries including freestanding composite Li—Mg alloy anodes may be subject to sluggish activation that requires several activation cycles to achieve rated discharge capacity. In some instances, prolonged activation may be observed when the Mg content in Li—Mg alloys is greater than approximately 10 wt %. Prolonged battery activation is not suitable for commercial lithium-sulfur battery applications. To mitigate sluggish activation, Li—Mg alloys may include one or more of lithium-ion conducting materials or electron conducting materials, or a combination thereof. Li-ion conducting materials may include one of lithium titanate (“LTO”), lithium lanthanum zirconium oxide (“LLZO”), lithium nitride (Li₃N), or lithium phosphide (Li₃P), or similar lithium-ion conducting materials including ceramic materials. Electron conducting materials may include one or more of carbon, aluminum, or silicon, or other similar electron conducting materials. The enhanced Li-ionic conductivity or electron conductivity of the example Li—Mg composite alloys including lithium-ion conducting materials or electron conducting materials may improve lithium utilization by reducing impedance associated with charge transfer during plating. Increasing the Mg content in Li—Mg alloys may also reduce material costs associated with the anode and improve the safety of lithium-sulfur batteries. Additional details related to the performance of lithium-sulfur coin cells including Li—Mg/LTO anodes are described below with reference to Example 3 and FIG. 10.

Without being bound by any particular theory, the example lithium-ion conducting materials or electron conducting materials may disperse in the bulk alloy and reduce the grain size of Li—Mg domains or reduce the diffusion length of Li⁺ ions in the Li—Mg bulk alloy to facilitate faster lithium-ion diffusion across grain boundaries. With faster lithium-ion diffusion, lithium-ion plating/stripping during charge/discharge cycles in lithium-ion batteries may be more uniform and mitigate dendrite growth. Dendrites may penetrate the polymeric or ceramic separators in Li-ion batteries and create a short circuit within a battery resulting in fire hazards.

In some implementations, a diffusion coefficient of lithium in Li—Mg/LTO composite alloys may be approximately 2.3×10⁻⁸ cm²/s, which is approximately an order of magnitude greater than the diffusion coefficient of lithium in Li—Mg alloys of approximately 3.8×10⁻⁹ cm²/s. Magnesium in Li—Mg/LTO alloys primarily controls the reactivity or stability of the alloy, and LTO reduces the size of Li—Mg domains and improves lithium-ion diffusivity. As such, improved lithium-sulfur battery cycle life and discharge capacities and a reduction in the N/P ratio to less than 2 may be possible with Li—Mg alloys including up to approximately 28 wt % Mg and an LTO content of up to approximately 40 wt %. Accordingly, the lithium content in example Li—Mg/LTO composite alloys may be reduced to between approximately 40 wt % and approximately 45 wt %, which in turn reduces material costs associated with the Li-ion battery anode.

Additionally, the melting point of a Li—Mg/LTO composite alloy is approximately 210° C., which is greater than the melting point of lithium of approximately 180° C. Battery safety is enhanced because the thermal runaway onset point in lithium-sulfur batteries increases from approximately 126° C. for a 90 wt % Li— 10 wt % Mg alloy to approximately 236° C. for a Li—Mg/LTO alloy, thereby increasing the temperature at which lithium-sulfur batteries associated with various aspects of the subject matter disclosed herein can be safely used by approximately 110° C.

In some implementations, the magnesium content in a freestanding Li—Mg alloy composite anode including a lithium-ion conducting material may be between approximately 10 wt % and approximately 28 wt %. As previously noted, example lithium-ion conducting materials may include one of lithium titanate (“LTO”), lithium lanthanum zirconium oxide (“LLZO”), lithium nitride (Li₃N), or lithium phosphide (Li₃P). In some instances, the amount of the lithium-ion conducting material in a freestanding Li—Mg alloy composite anode may be between approximately 10 wt % and approximately 40 wt %. In some other instances, the weight ratio of the Li—Mg alloy to the lithium-ion conducting material may be between approximately 1 and approximately 9. In some other instances, the weight ratio of the Li—Mg alloy to the lithium-ion conducting material may be approximately 1.5.

As previously described herein, example lithium-magnesium alloy composite anodes may include lithium-ion conducting materials in an amount between approximately 10 wt % and approximately 40 wt %. Example lithium ion conducting materials may include one or more of lithium titanate (“LTO”), lithium lanthanum zirconium oxide (LLZO), lithium nitride (Li₃N), or lithium phosphide (Li₃P).

However, in some implementations, lithium-magnesium alloy composite anodes including at least 10 wt % of one or more lithium-ion conducting materials may be characterized by an undesirable increase in the weight of the anode. An increase in the weight of the anode would decrease the specific capacity (mAh/g) or specific energy (Wh/kg) of example lithium-sulfur batteries. For example, in some implementations, increasing the LTO content in lithium-magnesium alloy composite anodes from approximately 10 wt % to approximately 50 wt % may decrease the specific capacity of lithium-sulfur batteries from approximately 2800 mAh/g to approximately 1400 mAh/g.

Without being bound by any particular theory, lithium-magnesium alloy composite anodes including nanosized ionic fillers may increase cycle life of lithium-sulfur batteries or reduce the number of activation cycles without incurring a penalty in the specific capacity associated with lithium sulfur batteries. Accordingly, in some implementations, a freestanding composite anode associated with a lithium-sulfur battery may include a Li—Mg alloy and one or more of a lithium-ion conducting material, an electron conducting material, or an ionic filler.

In some implementations, lithium-magnesium alloy composite anodes may include an ionic filler including one or more of alumina or titanium oxide (TiO₂) nanoparticles having an average particle size (d₅₀) of less than 50 nm as ionic fillers. In some other instances, lithium-magnesium alloy composite anodes may include an ionic filler including one or more of alumina or titanium oxide (TiO₂) nanoparticles having an average particle size (d₅₀) of between approximately 10 nm and approximately 50 nm. Additional details related to the performance of lithium-sulfur cells including Li—Mg alloy composite anodes including one or more of a lithium-ion conducting material or an ionic filler are described below with reference to Example 7 and Example 8. As referred to herein in this disclosure, an ionic filler is an ionic compound that includes positively charged metal ions and negatively charged non-metal ions. As referred to herein, an ionic filler is generally not considered to be a lithium ion-conducting material.

In some implementations, lithium-magnesium alloy composite anodes associated with lithium-sulfur cells may include one or more of approximately 10 wt % LTO or approximately 10 wt % TiO₂. An example lithium-magnesium alloy may include a 90 wt % Li— 10 wt % Mg alloy.

In some implementations, an amount of a lithium-ion conducting material in lithium-magnesium alloy composite anodes may be between approximately 10 wt % and approximately 40 wt %.

In some other implementations, an amount of an ionic filler in lithium-magnesium alloy composite anodes may be between approximately 10 wt % and approximately 40 wt %. In some other implementations, an amount of an ionic filler in lithium-magnesium alloy composite anodes may be approximately 10 wt %.

In some implementations, an example lithium-magnesium alloy composite anode may include approximately 80 wt % Li—Mg alloy, approximately 10 wt % LTO, and approximately 10 wt % TiO₂. An example lithium-magnesium alloy may include a 90 wt % Li— 10 wt % Mg alloy.

In some other implementations, an example lithium-magnesium alloy composite anode may include approximately 62 wt % Li, approximately 18 wt % Mg, approximately 10 wt % LTO and approximately 10 wt % TiO₂. In some examples, a Li—Mg alloy may include approximately 90 wt % Li and approximately 10 wt % Mg.

In some implementations, lithium-magnesium alloy composite anodes may include a lithium-ion conducting material having an average particle size (d₅₀) of between approximately 0.5 μm and approximately 2 μm. As previously described herein, example lithium ion conducting materials may include one or more of LTO, lithium lanthanum zirconium oxide (“LLZO”), lithium nitride (Li₃N), or lithium phosphide (Li₃P).

In some implementations, example electron conducting materials in a freestanding composite anode may include one or more of carbon, aluminum, or silicon. In some instances, carbon may include graphite.

In some other implementations, a freestanding anode associated with a lithium-sulfur battery may include a Li—Mg ternary alloy. In some other implementations, a freestanding anode associated with a lithium-sulfur battery may include a Li—Al—Mg ternary alloy. In some instances, an aluminum content in a Li—Al—Mg ternary alloy may be between approximately 5 wt % and approximately 20 wt %. In some instances, a Li—Al—Mg ternary alloy may further include any one of the lithium-ion conducting materials previously described herein. Without being bound by any particular theory, Li—Al intermetallic phases, for example, Li₃Al or Li₉Al₄, or similar phases, may be embedded in the Li—Mg alloy microstructure in Li—Al—Mg ternary alloys. These Li—Al intermetallic phases are lithiophilic, and may reduce localized current density profiles, facilitate more uniform lithium deposition (or plating), and improve the rates of lithium-ion diffusion.

In some implementations, a freestanding anode associated with a lithium-sulfur battery may include a Li—Si—Mg ternary alloy. In some instances, the silicon content in a Li—Si—Mg ternary alloy may be between approximately 5 wt % and approximately 20 wt %. In some instances, the silicon content in a Li—Si—Mg ternary alloy may be approximately 20 wt %. In some instances, a Li—Si—Mg ternary alloy may further include any one of the lithium-ion conducting materials previously described herein.

In some other implementations, a freestanding composite anode associated with a lithium-sulfur battery may include a Li—Mg/carbon alloy. In some instances, the carbon content in a Li—Mg/C alloy may be between approximately 1 wt % and approximately 20 wt %. In some other instances, carbon may include graphite. In some instances, the carbon content in an example Li—Mg/C alloy may be approximately 15 wt %. In some instances, a Li—Mg/C alloy may further include any one of the lithium-ion conducting materials previously described herein.

In some other implementations, carbon in the example Li—Mg/C alloys may include one or more of carbon nanotubes (“CNT”), carbon nano onions (“CNOs”), carbon nanofibers, or fullerenes. In some instances, carbon may be surface functionalized using CO₂ etching and other methods to include surface oxygen containing functional groups. Without being bound by any particular theory, carbon, and in particular graphite, is an electronically conductive additive, and may also function as a current collector, which may dramatically increase the active surface area of the anode and also mitigate dendrite growth. As such, the addition of carbon may increase lithium utilization, discharge capacity, rate capability, and cyclic stability in Li-ion and lithium-sulfur batteries.

In some implementations, a grain size of Li—Mg domains in any one of the Li—Mg alloys previously described herein may be manipulated via annealing or rapid quenching operations associated with the thermal treatment and mechanical processing of Li—Mg alloys. For example, Li—Mg domain grain growth may be mitigated by annealing Li—Mg alloys at 70% of the melting point of the alloy. In some implementations, annealing Li—Mg alloys associated with lithium-sulfur battery anodes at approximately 150° C. may improve the capacity retention and columbic efficiency of lithium-sulfur batteries. Annealing or rapid quenching may also alter the orientation of body centered cubic (“BCC”) crystalline grain structure in Li—Mg alloys to preferred orientations, for example, the (110) plane or the (200) plane. In some implementations, the grain size of Li—Mg domains in Li—Mg alloys or any one of the Li—Mg composite alloys describe herein after annealing may be less than approximately 175 μm.

Any one of the freestanding anode implementations previously described herein may also be used in other lithium-ion battery chemistries including, but not limited to, nickel-manganese-cobalt (“NMC”) batteries, lithium iron phosphate (“LFP”) batteries, or nickel cobalt aluminum oxide (“NCA”) batteries.

In some implementations, any of the freestanding Li—Mg alloy/anodes previously disclosed herein may include an anode protective polymer coating including one or more of polyvinylidene fluoride (“PVDF”), pentaerythritol tetraacrylate (“PETEA”), or polyethylene glycol dimethacrylate (“PEGDMA”), or any combination thereof, disposed on the freestanding anode. The thickness of the coating layer may be between approximately 1 μm and approximately 10 μm.

In some implementations, an example lithium-sulfur battery may include any one of the freestanding anodes previously described herein and a fluorinated ether electrolyte. The thickness of the freestanding anode may be approximately 100 μm. In some instances, a freestanding anode may include any one of the dual-phase alloy anodes including a Li—Mg alloy phase and a Li₂Ca alloy phase. In some other instances, a freestanding anode may include any one of the Li—Mg alloy composite anodes including a lithium-ion conducting material or an electron containing material.

In some implementations, an example fluorinated ether electrolyte may include one or more of lithium nitrate (LiNO₃) or lithium bis (trifluoromethanesulfonyl) imide (“LiTFSI”). In some implementations, the concentration of LiTFSI in the fluorinated electrolyte may be between approximately 0.1M and approximately 2M. In some other implementations, the concentration of LiNO₃ in the fluorinated ether electrolyte may be between approximately 2 wt % and approximately 6 wt %.

In some implementations, an example fluorinated ether electrolyte may include approximately 50:25:25 (vol %) 1,2-dimethoxyethane (“DME”): 1,3-dioxolane (“DOL”): bis (2,2,2-trifluoroethyl) ether (“BTFE”) and including approximately 0.4 M LiTFSI and approximately 2 wt.-% LiNO₃. In some other implementations, an example fluorinated ether electrolyte may include approximately 50:25:25 (vol %) DME: DOL: 1,1,2,2-tetraethoxyethane (“TEE”) and including approximately 0.4 M LiTFSI and approximately 2 wt % LiNO₃.

In some implementations, an example electrolyte may include approximately 50:25:25 (vol %) DME: DOL: 1,1,2,2-tetrafluoroethyl 2,2,2-trifluoroethyl ether (“TFETFE”) and including approximately 0.4 M LiTFSI and approximately 2 wt % LiNO₃. In some other implementations, an example electrolyte may include approximately 60:20:10:10 (vol %) DME: DOL: TEE: TFETFE and including approximately 0.4 M LiTFSI and approximately 2 wt % LiNO₃.

In some implementations, an example electrolyte may include approximately 50:25:25 (vol %) DME: DOL: 1,1,2,2-tetrafluoroethyl-2,2,3,3-tetrafluoropropyl ether (“TTE”) and including approximately 0.4 M LiTFSI and approximately 2 wt % LiNO₃. In some other implementations, an example fluorinated ether electrolyte may include LiTFSI at concentrations of between approximately 0.1 M and approximately 1 M, and LiNO₃ concentrations of between approximately 1 wt % and 6 wt %. In some other implementations, an example fluorinated ether electrolyte may include approximately 50:25:25 (vol %) DME: DOL: 1 fluorinated 1,4-dimethoxylbutane (“FDMB”) and including approximately 0.4 M LiTFSI and approximately 2 wt % LiNO₃. In some other implementations, the electrolyte may include approximately 1.0 M LiTFSI in approximately 50:50 (vol %) DOL: BTFE.

Additives including lithium nitrate (LiNO₃) in fluorinated ether electrolyte may dissociate to produce lithium cations (Li⁺). Alternately, additives including LiTFSI in the electrolyte may dissociate to produce lithium cations (Li⁺) and TFSI⁻0 anions. Additives in the electrolyte that may dissociate to lithium ions may also include one or more of lithium lanthanum zirconium oxide (“LLZO”), oxinitrides (e.g., lithium phosphorus oxynitride or “LIPON”), NASICON-type conductors (e.g., lithium aluminum titanium phosphate) or lithium tin phosphorus sulfide (“LSPS”).

In some example implementations, any one of the previously described freestanding dual phase Li—Mg alloy and Li-x alloy anodes or any of the Li—Mg alloy composite anodes including Li-ion conducting material or electron conducting material may be coated with a surface coating which may react with lithium in the alloy to form a protective layer and further improve the stability of the anode under cycling. In some instances, the anode protective layer may include one or more of polyvinylidene fluoride (“PVDF”), pentaerythritol tetraacrylate (“PETEA”), or polyethylene glycol dimethacrylate (“PEGDMA”), or any combination thereof, disposed on the freestanding anode. In some other instances, a thickness of the anode coating layer may be between approximately 1 μm and approximately 10 μm.

Without being bound by any particular theory, PVDF may react with lithium in the freestanding Li—Mg alloy anode to form LiF⁻ ions dispersed in a polymeric matrix. The protective layer may improve and/or may be associated with an improvement of lithium ion (Li⁺) transport from and to the anode during cycling. Reducing lithium-containing dendritic growth from the anode of a Li—S battery may increase the charge rate, the discharge rate, the energy density, the cycle life, or any combination thereof. The polymeric matrix may partially trap TFSI-anions produced by the dissociation of additives including LiTFSI in the electrolyte.

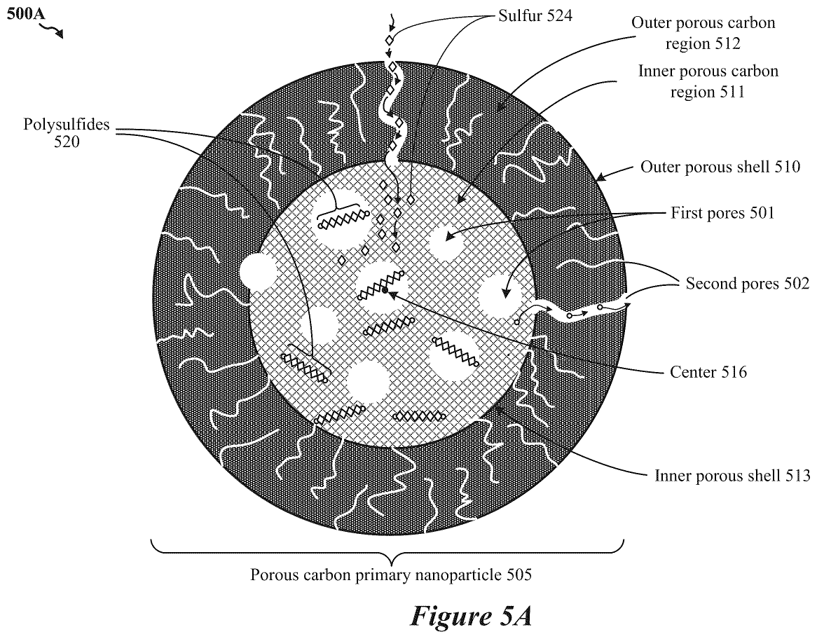

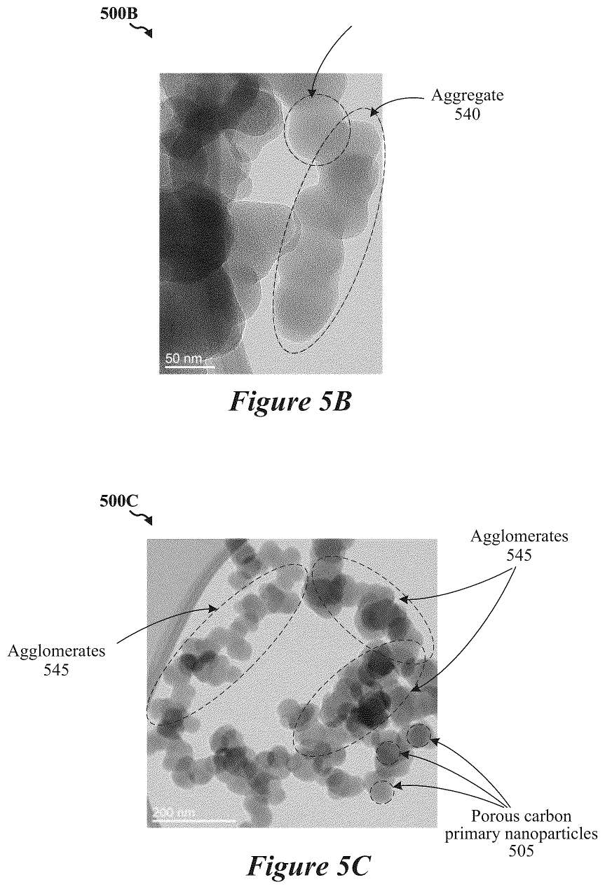

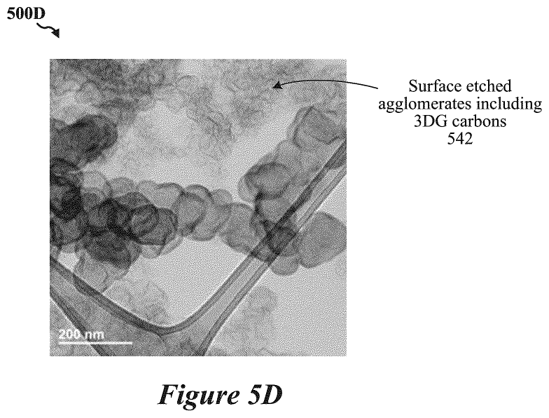

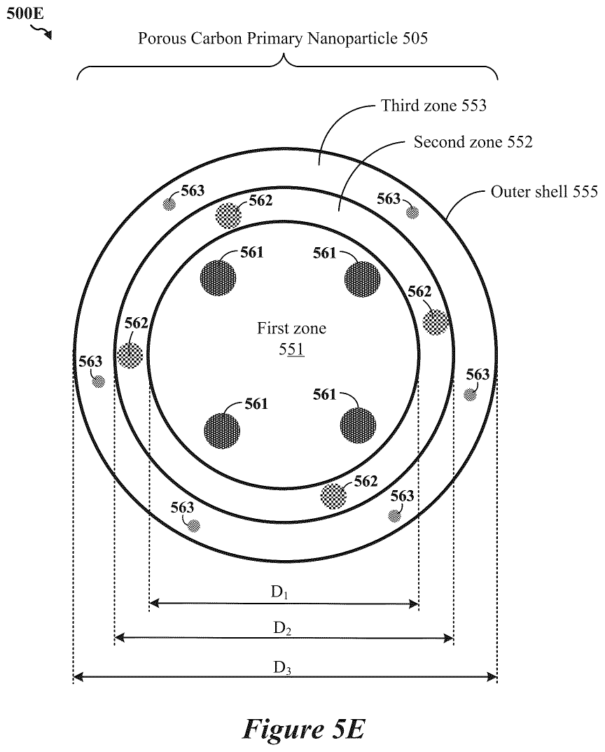

In some implementations, an example lithium-sulfur battery may include a cathode disposed opposite to the anode. As described below with reference to FIGS. 5A-5E, in some implementations, an example cathode may include one or more porous carbon layers including porous carbon agglomerates of porous carbon primary nanoparticles. In some instances, a respective porous carbon primary nanoparticle may include an inner porous shell disposed about a center of the respective porous carbon primary nanoparticle and enclosing an inner porous carbon region, an outer porous shell enclosing an outer porous carbon region disposed between the inner shell and the outer shell, and an interconnected porous network disposed in and in fluid communication with the inner and outer porous carbon regions.

In some aspects, the inner carbon region and the outer carbon region of example porous carbon primary nanoparticles may be characterized by an average pore size and an average pore density associated with each region. In some other aspects, the average pore size may decrease along a radial direction from the center to the outer porous shell.

In some instances, an example porous carbon primary nanoparticle may further include one or more intermediate porous shells disposed between the inner porous shell and the outer porous shell, wherein each of the intermediate porous shells encloses a respective intermediate porous carbon region.

In some aspects, the porous carbon agglomerates may be characterized by a Raman spectroscopy signature with an I_{D}/I_{G} ratio between approximately 0.95 and approximately 1.05. In some other aspects, the porous carbon agglomerates may be characterized by a Brunauer-Emmett-Teller (“BET”) surface area between approximately 50 m²/g and 300 m²/g measured using nitrogen gas. In some aspects, the porous carbon agglomerates may be characterized by an electrical conductivity of between approximately 500 S/m and 20,000 S/m when compressed at a pressure of approximately 12,000 pounds per square inch (psi).

FIG. 5A shows a schematic diagram 500A of an example porous carbon primary nanoparticle 505, according to some implementations. In some aspects, the porous primary carbon nanoparticle 505 may resemble carbon nano-onions (“CNOs”). As shown in the example of FIG. 5A, the porous primary carbon nanoparticle 505 may include a core (inner) porous carbon region 511 defined by a first porosity and enclosed within an inner porous shell 513. The inner porous carbon region 511, which may also be referred to herein as the first porosity region, may include a plurality of first pores 501 dispersed therein. An outer porous carbon region 512, which may also be referred to herein as the second porosity region, may be disposed between the inner porous shell 513 and an outer porous shell 510 and may include a plurality of second pores 502 dispersed therein. The inner porous carbon region 511 and the outer porous carbon region 512 may be interconnected by one or more of the first pores 501 or one or more of the second pores 502, thereby interconnecting the first and second porosity regions. That is, the inner porous carbon region 511 may be configured to be in fluid communication with the outer porous carbon region 512 through an interconnected porous network. The inner porous carbon region 511 may be defined by a first pore density, and the outer porous carbon region 512 may be defined by a second pore density that is similar to, or different than, the first pore density.

Example porous primary carbon nanoparticle 505 may be characterized by an average size or principal dimension (diameter, length, width) of less than approximately 200 nm. In some implementations, an average pore size may gradually decrease along a radial direction from the center 516 of the nanoparticle 505 to the outer boundary 513 of the nanoparticle 505. In some implementations, porous primary carbon nanoparticle 505 may be characterized by a range of pore sizes and pore distributions in each region. The first pores 501 may be configured to retain polysulfides 520, and the second pores 502 may provide pathways or channels for the transport of lithium ions (not shown for simplicity) into and from the porous primary carbon nanoparticles 505 and for pre-loading sulfur 524 into the nanoparticles.

FIG. 5B shows a transmission electron microscopy (“TEM”) micrograph 500B of aggregates 540 of porous primary nanoparticles 505, according to some implementations. Those skilled in the art will appreciate that the micrographs are shown by way of example only, and that other scales may exist without departing from the scope and spirit of the present implementations. Example carbon aggregates 540 may include an interconnected porous network disposed between adjacent carbon nanoparticles 505. Aggregate 540 may include a plurality of porous carbon primary nanoparticles 505 and, in some instances, may resemble a “string-of-pearls.” In some implementations, the size or principal dimension of aggregate 540 may be between approximately 50 nm and approximately 500 nm.

FIG. 5C shows a TEM image 500C of agglomerates 545 of porous primary carbon nanoparticles 505, according to some implementations. An agglomerate 545 of porous carbon primary nanoparticles 505 may be characterized by a Brunauer-Emmett-Teller (“BET”) surface area of between approximately 50 m²/g and approximately 300 m²/g measured using nitrogen gas. In some implementations, an example agglomerate 545 may be spherical in shape. In some implementations, an agglomerate 545 may be of any shape, including one or more of spherical, spheroidal, dumbbell, cylindrical, elongated cylindrical type, rectangular prism, disk, wire, or irregular.

FIG. 5D shows a TEM image 500D of surface etched agglomerates 542 of porous primary carbon nanoparticles, according to some implementations. Example agglomerates 545 may be surface etched using methods that include CO₂ etching to create pores on the external surface of the agglomerates 545 and to increase the surface area of the carbon agglomerates 545 to yield surface etched agglomerates 542. After etching, the surface etched agglomerates 542 may include three-dimensional graphene carbons (“3DG carbons”) including graphene layers interconnected as three-dimensional (“3D”) graphene structures (not shown for simplicity). The surface etched agglomerates 542 of porous primary carbon nanoparticles may be characterized by a Raman spectroscopy signature with an ID/IG ratio of approximately between 0.95 and 1.05. In some instances, the surface etched agglomerates 542 may be assembled as rigid porous carbon agglomerates by processes including spray drying.

FIG. 5E shows a schematic diagram 500E of another example porous primary carbon nanoparticle 505, according to some implementations. Example tri-zone porous primary nanoparticle 505 may include a first core (inner) carbon zone or region 551, nested within a second intermediate carbon zone or region 552, which in turn is nested within a third outer carbon zone or region 553. Example first zone 551 may include pores 561 having an average size or principal dimension (diameter, length width) of less than approximately 40 nm, the second zone 552 may include pores 562 having an average size or principal dimension of less than approximately 35 nm, and the third zone 553 may include pores 563 having an average size or principal dimension of less than approximately 30 nm. In some example implementations, pores 561 may be characterized as macropores, the pores 562 in the intermediate region 552 may be characterized as mesopores, and the pores 563 in the outer region 552 as micropores.

In some implementations, the principal dimension D1 of first zone 551 may be less than approximately 100 nm, the principal dimension D2 may be less than approximately 150 nm, and the principal dimension D3 of third zone 553 may be approximately 200 nm. The relative dimensions, porosities, and electrical conductivities of the first zone 551, the second zone 552, and the third zone 553 may be tuned to achieve a desired balance between minimizing the polysulfide shuttle effect and maximizing the specific capacity of a host battery. The first zone (inner core zone) 551 may have a density of carbons of less than approximately 1 g/cc. The third zone (outer zone) 553 bounded by the perimeter or outer shell 555 of particle 205 may have a density of carbons of approximately less than between 1 g/cc and 3.5 g/cc. The second zone (intermediate zone) 552 may have a density of carbons of between approximately 0.5 g/cc and 3 g/cc. Each of the zones 551, 552, and 553 may be characterized by an average pore size and an average pore density associated with each region. The average pore size associated with each of zones 551-553 may decrease along a radial direction from the center of the porous primary carbon nanoparticle 505 to the outer porous shell 555.

In some implementations, agglomerates of porous primary carbon nanoparticles 505 may be surface etched using methods that include CO₂ etching to create pores on the external surface of the agglomerates and to increase the surface area of the carbon agglomerates. After etching, the agglomerates may include three-dimensional graphene carbons (“3DG carbons”) including graphene layers interconnected as three-dimensional (“3D”) graphene structures. The resulting surface etched agglomerates of porous primary carbon nanoparticles 505 may be characterized by a Raman spectroscopy signature with an I_{D}/I_{G} ratio of approximately between 0.95 and 1.05. In some implementations, the resulting agglomerates may be produced by thermal cracking of hydrocarbon feedstock as disclosed in commonly-owned U.S. Pat. No. 9,862,602, U.S. Pat. No. 10,112,837, U.S. Pat. No. 11,053,121, and/or U.S. Pat. Pub. No. 2021/0292170, all of which are incorporated by reference herein in each of their entireties.

The porous carbon agglomerates as described above may be used to produce carbon-sulfur composites (“CSC”) by sulfurizing the carbon agglomerates. The sulfur to carbon weight ratio may be between approximately 1:5 and 10:1. The sulfur to carbon weight ratio may be approximately 3. A slurry including the carbon-sulfur composites and one or more polymeric binders may be cast as one or more layers or films of carbon material on a suitable substrate to form the cathode in an example Li—S battery. The cathode substrate may include a cathode current collector. The cathode current collector may include aluminum. The carbon agglomerates may resist deformation under high shear mixing and therefore produce films or layers of carbon of desired porosity, thickness, and packing density. In some implementations, the cathode may be characterized by a packing density of carbon material on the substrate (including sulfur, binder, and other constituents) of at least approximately 7 mg/cm², which in turn increases the sulfur loading at the cathode and may reduce the N/P ratio in a Li—S battery.

In some implementations, the porous carbon agglomerates as disclosed herein may resist deformation under high shear mixing and therefore produce films or layers of carbon of desired porosity, thickness, and packing density. In some implementations, the porous carbon agglomerates may resist deformation at shear rates of at least 500 s⁻¹ during mixing of a slurry including the porous carbon agglomerates in a high shear mixer. The slurry may be disposed as one or more porous carbon layers on the cathode substrate (also referred to herein as the cathode current collector).

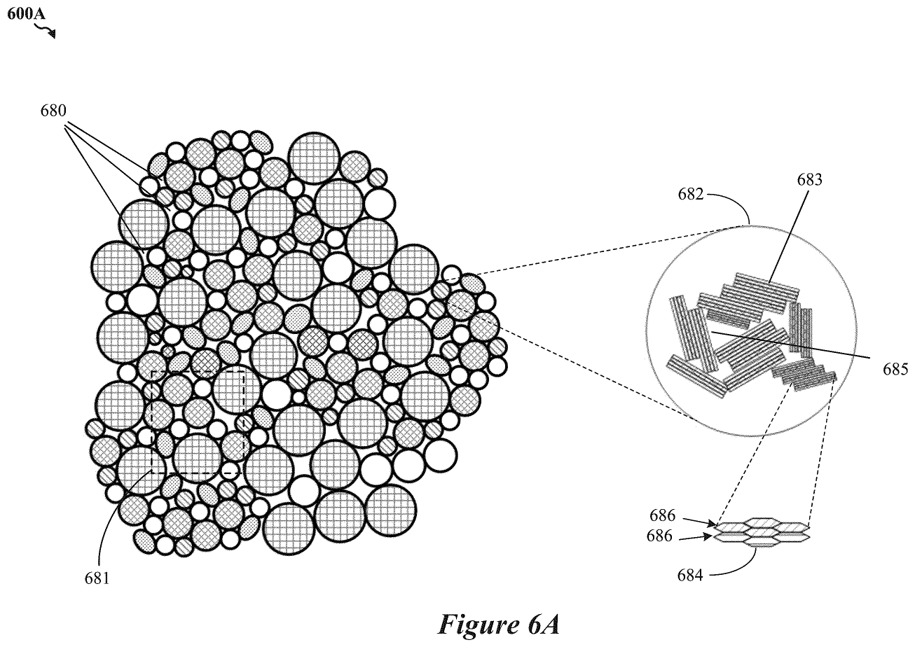

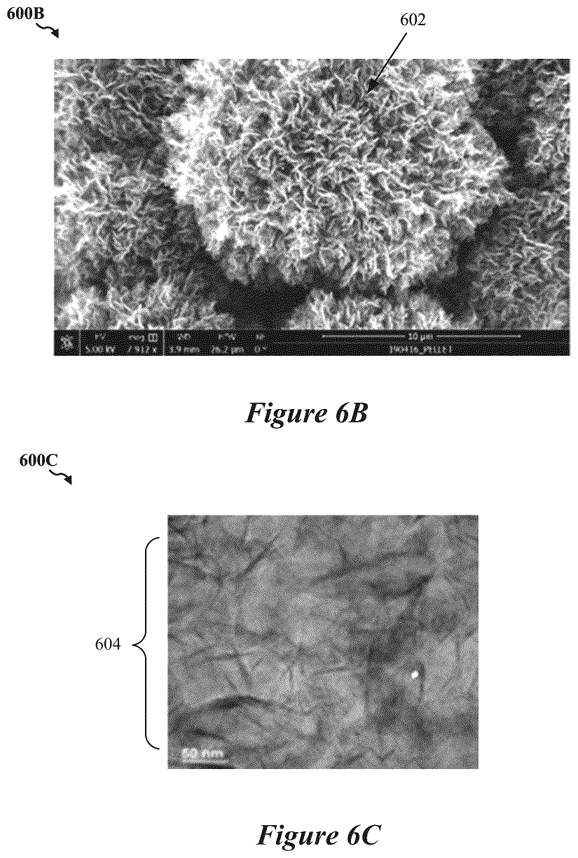

In some implementations, as described below with reference to FIGS. 6A-6C, an example cathode for a lithium-sulfur battery may include porous carbon agglomerates of porous carbon primary nanoparticles, which include one or more interconnected bundles of electrically conductive graphene layers. In some aspects, the graphene layers may be arranged as one or more stacks connected to each other and defining a 3D porous scaffold structure including mesopores. In some other aspects, the one or more stacks may be disposed substantially orthogonal to each other. In some instances, the graphene layers may be characterized by a linear dimension of between approximately 50 nm and 200 nm. In some other instances, the graphene layers may include one or more of single layer graphene (“SLG”), few layer graphene (“FLG”), or many layer graphene (“MLG”).

FIG. 6A shows a schematic diagram of a mesoporous carbon nanoparticle 600A having an interconnected bundle of electrically conductive graphene layers arranged to form a 3D open porous scaffold structure, according to some implementations. Nanoparticle 600A and porous carbon agglomerates including nanoparticles 600A may be produced using a high throughput, low-cost, cracking of a hydrocarbon gas such as natural gas, in an atmospheric microwave plasma reactor. An example microwave plasma reactor is disclosed in commonly-owned U.S. Pat. No. 9,767,992, which is incorporated by reference herein in its entirety. For example, the agglomerates may be formed in-flight and grown by adding additional carbon-based materials derived from incoming carbon-containing gas within a microwave-plasma reaction chamber.

The carbon nanoparticles 600A may include three-dimensional (“3D”) multi-modal mesoporous carbon nanoparticles. A mesoporous material, as generally understood and as referred to herein, includes a material containing pores with diameters between 2 nm and 50 nm, according to IUPAC nomenclature. For the purposes of comparison, IUPAC defines microporous material as a material having pores smaller than 2 nm in diameter and defines macroporous material as a material having pores larger than 50 nm in diameter. In some instances, mesoporous carbon particle 600A may be characterized by a three-dimensional (“3D”) hierarchical porous structure including pores 680. In some aspects, at least a portion of the hierarchical porous structure may further define a 3D open porous scaffold structure 681.

The nanoparticle 600A may include one or more interconnected bundles 682 of electrically conductive graphene layers or sheets. Each interconnected bundle 682 may include one or more stacks 683 of graphene layers. Each stack 683 may include a plurality of graphene layers 686 that are generally stacked horizontally as more clearly shown in stack 684. One or more stacks 683 of graphene layers 686 may be arranged to form a 3D porous scaffold structure 681 including mesopores. That is, a plurality of stacks 683 of electrically conductive graphene layers 686 may be sintered together to define the 3D open porous scaffold structure 681 (which includes mesopores 680 in the example of FIG. 6A). In some implementations, one or more of the stacks 683 may be connected substantially orthogonal to each other. The open porous scaffold structure 681 may be configured to provide electrical conduction between contact points (not shown for simplicity) of the stacks of graphene layers 686. In some implementations, each graphene layer 686 may be characterized by a diameter or linear dimension (“La”) of between approximately 50 nm to approximately 200 nm. In some implementations, the graphene stack 683 may include few layer graphene (“FLG”), which may be composed of 5 to 15 layers of graphene.

A plurality of porous carbon primary nanoparticles 600A may be coalesced or joined to form porous carbon agglomerates of porous carbon primary nanoparticles. In this disclosure, three-dimensional graphene carbons (“3DG carbons”) include porous carbon agglomerates of mesoporous nanoparticles 600A. In some implementations, the example 3DG carbons described herein may be characterized by a Brunauer-Emmett-Teller (“BET”) surface area measured using nitrogen gas of approximately 50 to 300 m²/g. In some implementations, the 3DG carbons may be characterized by a graphene to amorphous carbon ratio of between approximately 1% and 95%. In some implementations, the 3DG carbons may be characterized by a carbon purity of at least 99.9%. The 3DG carbons may be characterized by an electrical conductivity of between approximately 500 S/m and approximately 20,000 S/m when compressed at pressure of approximately 12,000 pounds per square inch (“psi”). The open porous scaffold structure 681, while confining sulfur, may also provide a host scaffold-type structure to manage volume expansion due to the formation of long chain polysulfides.

In some implementations, sulfur may be confined in the pores 680 of open porous scaffold structure 681. In some implementations, sulfur may also be confined in the scaffold structure spaces 685 formed by orthogonally joined stacks 683 of graphene layers 684.

In some implementations, the porous carbon primary nanoparticles 600A may include a plurality of interconnected crinkled 3D graphene sheets, a plurality of non-hollow carbon spherical particles (“NHCS”), flat graphene, wrinkled graphene, or a plurality of carbon nano-onions (“CNOs”). In some implementations, the porous carbon primary nanoparticles 600A may include wavy or flexible graphene layers that resemble crinkled paper and may be produced using microwave processes. The graphene layers may be flexible as they may be fused with each other at sp³ type defects in a sp² graphene lattice structure.

FIG. 6B shows a SEM micrograph 600B of porous carbon agglomerates 402, according to other implementations. In some instances, plasma-based processing conditions applied or performed in a reactor such as a microwave reactor may be adjusted with a high degree of tunability to achieve of porous carbon agglomerates and graphene-on-graphene densification to yield the complex 3D carbons 602. The porous carbon agglomerates 602 may be surface etched using methods such as CO₂ etching to create pores on the external surface of the aggregates and to increase the surface area of the aggregates.

The porous carbon agglomerates described herein and characterized using Raman spectroscopy show a high degree of order and uniformity of structure. In this disclosure, “graphene” refers to an allotrope of carbon in the form of a two-dimensional, atomic-scale, hexagonal lattice in which one atom forms each vertex. The carbon atoms in graphene may be sp² hybridized carbon atoms. Additionally, graphene has a Raman spectrum with two main peaks: a G-mode at approximately 1580 cm⁻¹ and a D mode at approximately 1350 cm⁻¹ (when using a 532 nm excitation laser). The porous carbon agglomerates may be characterized by a Raman spectroscopy signature having an ID/IG ratio between approximately 0.95 and approximately 1.05.

FIG. 6C shows a TEM micrograph 600C of porous carbon agglomerates, according to some implementations. As shown, the 3D few-layer graphene (“FLG”) structure 604 may be considered to be a porous carbon aggregate at a 50 nm scale. Those skilled in the art will appreciate that the micrographs are shown by way of example only, and that other scales may exist without departing from the scope and spirit of the present implementations.

Any one of the Li—S battery cathode or anode implementations previously described herein may be configured or disposed for use in cylindrical batteries, prismatic batteries, pouch cells, or any other suitable geometrical shape. A Li—S cylindrical battery may comport with the dimensions of an 18650 battery (approximately 18 mm diameter×approximately 65 mm length), a 21700 (approximately 21 mm diameter×approximately 70 mm length) battery or a 4680 (approximately 46 mm diameter×approximately 80 mm length) battery. In some implementations, a Li—S battery may have a prismatic form factor that can comport with the dimensions of a CP3553 battery. For example, an example Li—S battery may have a height between approximately 56 mm and approximately 58 mm, a length between approximately 34 mm and approximately 36 mm, and a width between approximately 6 mm and approximately 8 mm.

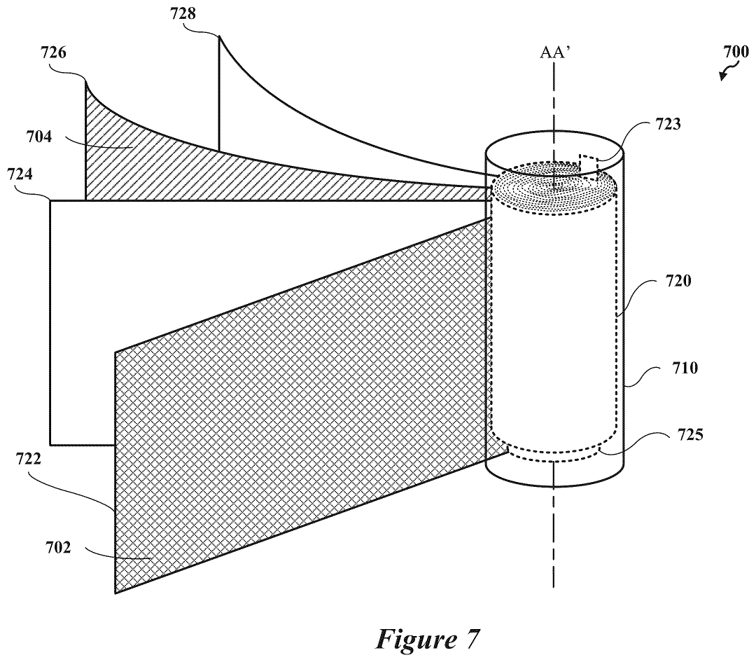

FIG. 7 shows a schematic diagram 700 depicting an example cylindrical battery 700, according to some implementations. Battery 700 may include a shell 710 and a jelly roll 720. Shell 710 may have a longitude axis indicated as AA' in FIG. 4, and jelly roll 720 may be disposed along the longitudinal axis AA' within shell 710. Jelly roll 720 may have a cross section in a circle, a rectangle, a square, a triangle, or any other geometric shapes. Jelly roll 720 may include an anode 722, a first barrier layer (or separator layer) 724, a cathode 726, and a second barrier layer 728, each in the form of a rollable sheet. Anode 722, first barrier layer 724, cathode 726, and the second barrier layer 728 may be laminated on top of one another. As such, anode 722 and cathode 726 may be separated by the first and the second barrier layers to avoid undesirable short circuiting within battery 700. In some other implementations, a center pin or mandrel (not shown in FIG. 7 for simplicity) may be attached to an inner edge of anode 722, and the lamination of cathode-first barrier layer-anode-second barrier layer may be radially wound or rolled around the center pin to form the jelly roll 720. Anode current collector 702 (in the event the anode is not a free-standing anode) and cathode current collectors 704 may be integrated into the anode and cathode layers, respectively.

In some implementations, anode 722, first barrier layer 724, cathode 726, and second barrier layer 728 may share the same dimensions, and the sheets may be aligned with one another during the rolling process so that there are no sheets protruding from the jelly roll 720. Either anode 722 or cathode 726 current collectors may include a current collector tab, which may protrude out after the sheets are wounded into the jelly roll 720. Tab 723 may connect the anode 722 or the cathode 726 to a negative or positive terminal (not shown in FIG. 7 for simplicity), respectively, via any suitable process including a mechanical welding process. In some implementations, tab 723 may be the cathode current collector tab. The anode current collector (not shown for simplicity) may be disposed at the outer edge of the jelly roll 720, and the cathode current collector tab 723 may be disposed approximately in the center of the jelly roll 720.

In some implementations, either electrode (e.g., the anode 722 or the cathode 726) may be arranged in a misalignment with the other electrode and the first and the second barrier layers 724 and 728 during the rolling process so that a portion 725 may protrude out of the jelly roll 720. In some aspects, an electron conductive glue (not shown in FIG. 7 for simplicity) may be disposed within shell 710 at the top and bottom of shell 710. The protruding portion 725 may be connected to the negative or positive terminal of shell 710 via electron conductive glue and thereby eliminates the need for a mechanical welding process. In some implementations anode 722, anode current collector (not shown), first barrier layer 724, cathode 726, cathode current collector 704 and the second barrier layer 728 may be laminated on top of one another. A center pin or mandrel (not shown in FIG. 7 for simplicity) may be configured as the cathode terminal and may be attached to the cathode current collector 704. When disposed as a jelly roll, the anode current collector may be disposed at the outer edge of the jelly roll 720, and the cathode current collector 404 may be disposed approximately in the center of the jelly roll 720.

In various implementations, anode 722 may be any suitable material that is typically used as an anode in a Li—S battery. For example, anode 722 may be a lithium foil or a lithium substrate. In some instances, anode 722 may include a current collector to support the lithium foil or the lithium substrate. In some aspects, the anode 722 may include any one of the free-standing Li-alloy anodes, including Li—Mg composite anodes and previously described herein.

In some implementations, cathode 726 may include one or more layers of films or CSC including any of the previously described rigid porous carbon agglomerates including metal nanoparticles. Cathode 726 may be disposed on the current cathode collector 704. The cathode films may coat both sides of a current collector, such as an aluminum foil, to provide the maximum cathode capacity. The cathode CSC including any of the previously described rigid porous carbon agglomerates having metal nanoparticles may include multiple pores to micro-confine sulfur as the cathode electroactive material. The electroactive material (sulfur) may constitute approximately between 60 wt % and 90 wt % of the cathode films. The electroactive material of the cathode 726 may include other suitable sulfur-containing materials, such as lithium sulfide.

Battery 700 may have electrolyte (not shown in FIG. 7 for simplicity) incorporated into the jelly roll 720. In some implementations, battery 700 may have a liquid electrolyte that may be added to shell 710 after jelly roll 720 is disposed in shell or casing 710. In some other implementations, battery 700 may include a non-aqueous electrolyte such as solid-state electrolyte, gel electrolyte, or polymer film electrolyte incorporated into jelly roll 720. For example, between the first and the second barrier layers 724 and 728, one barrier layer may function as a separator and the other one may function as a non-aqueous electrolyte film. In some other implementations, each of the first and second barrier layers 724 and 728 may function as both a separator and a non-aqueous electrolyte film. The electrolyte may include any one of the electrolyte compositions previously described herein.

In some implementations, a microporous monolayer polypropylene membrane may be used as a separator disposed between the anode 722 and the cathode 726. The porosity of an example separator (e.g., Celgard^{R} 2500) may be approximately 55%. The separator may have a similar ionic conductivity as the electrolyte but may serve to reduce lithium dendrite formation. The separator may be formed from a ceramic containing material that does not chemically react with metallic lithium. As a result, the separator with ceramic containing material may be used to control lithium-ion transport through the pores dispersed across the separator, while concurrently preventing a short-circuit by impeding the flow or passage of electrons through the electrolyte. The separator layer may include a mechanical strength enhancer coated and/or deposited on the anode. The mechanical strength enhancer may provide structural support for the battery, may prevent lithium dendrite formation from the anode, and/or may prevent protrusion of lithium dendrite throughout the battery. In some exemplary implementations, ceramic particles may be impregnated in the microporous monolayer polypropylene membrane. In some exemplary implementations, the separator may include a ceramic coated separator.

In a cylindrical Li-ion battery, the dense packing of the various layers in the jelly roll 720 and volume changes during discharge-charge cycling may cause mechanical stresses and ageing of the battery 700. As previously described, volume changes may result from non-uniform lithium plating and dendrite formation at the anode, polysulfide “shuttle effect” and growth of solid electrolyte interfaces. Dendrites may even cause fires due to localized heating. Also, pit formation on the anode 722 leads to non-homogenous transport of Li ions from the anode 722 to the cathode 726 and also to fracture of the protective coating/layers disposed on the anode. Similarly, during the charging cycle, lithium dendrites may be formed on the metal anodes due to non-homogenous transport and deposition of Li ions from the cathode to the anode. Pitting and/or dendrite formation leads to uneven stresses and volumetric expansion of the jelly roll 720, which over time causes the layers of the jelly roll 720 to lose intimate contact with one another to exacerbate these issues and lead to accelerated degradation/capacity fade. Cathodes including any one of the previously described CSC materials including any of the previously described porous carbon agglomerates, Freestanding anodes including any one of the Li—Mg alloy compositions, and any one of the previously described electrolyte compositions may mitigate the polysulfide shuttle effect and the effect of mechanical stresses and increase the cycle life of Li—S batteries.

### EXAMPLES

In the examples described below, the electrolyte used in the Li—S battery implementations include approximately 50:25:25 (vol %) DME: DOL: BTFE and including approximately 0.4 M LiTFSI and approximately 2 wt % LiNO₃. For symmetric half-cell Li—S battery tests, the example electrolyte may include approximately 1M lithium polysulfides, Li₂S₆.

### Example 1

Cathode Discharge Capacity of Lithium-Sulfur Coin Cells Including a Freestanding Dual-Phase Alloy Anode Including Li—Mg Alloy and a Li₂Ca alloy at C/3 Discharge Rate

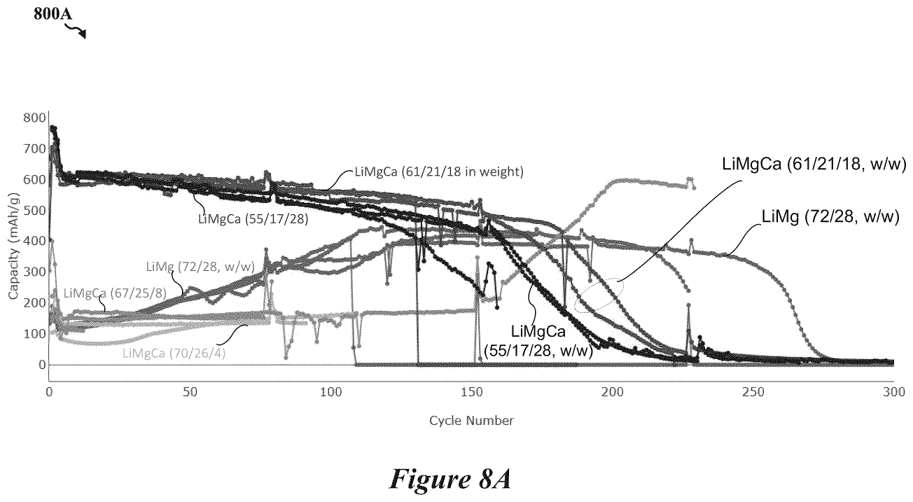

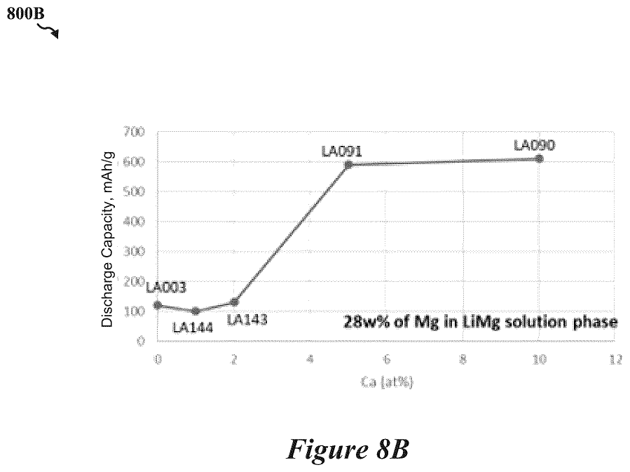

FIG. 8A shows a plot 800A illustrating cathode discharge capacity of lithium-sulfur coin cells including freestanding dual-phase anodes including a Li—Mg alloy phase and a Li₂Ca alloy phase, according to some implementations. Cathode discharge capacity at C/3 rate of example lithium-sulfur coin cells was compared to cells including 72 Li-28 Mg alloy (72 wt % lithium, 28 wt % magnesium). Four dual-phase alloys including Li—Mg-Ca contents (wt %) of (a) 61% Li, 21% Mg, 18% Ca, (b) 55% Li, 17% Mg, 28% Ca, (c) 67% Li, 25% Mg, 8% Ca, and (d) 70% Li, 26% Mg and 4% Ca were evaluated as freestanding anode alloy candidates. The weight ratio of Li—Mg alloy to the Li₂Ca alloy was between approximately 0.1 and approximately 20. The anode thickness in each case was approximately 100 μm. Formation cycles included 2 discharge/charge cycles at C/20 rate and 1 cycle at C/10 rate. The cathode loading was approximately 7.5 mg/cm². The cathode capacity in each case was approximately 4 mAh/cm². A Celgard PP2075 separator was used between the cathode and anode. The anode did not include any polymeric material coating. The E/S ratio was approximately 5.

Referring to FIG. 8A, the cells with dual-phase alloy anodes including 61% Li, 21% Mg, 18% Ca, and 55% Li, 17% Mg, 28% Ca provided a discharge capacity of at least 400 mAh/g at approximately 150 cycles when compared to the 72 Li-28 Mg alloy, which required approximately 100 formation cycles to reach a discharge capacity of approximately 400 mAh/g.

To examine the effect of calcium content on discharge capacity, alloys were prepared with calcium content varying from 2 at % (atomic %) to 10 at % in the dual-phase alloy including Li—Mg alloy and Li₂Ca alloy. FIG. 8B shows another plot 800B illustrating cathode discharge capacity of lithium-sulfur coin cells including dual-phase freestanding anodes including a Li—Mg alloy phase and a Li₂Ca alloy phase, according to some implementations. As can be seen, calcium content of at least 5 at % is required to realize a discharge capacity of approximately 600 mAh/g. Without being bound by any particular theory, it appears that increasing the calcium content in the example dual-phase alloy anodes results in a significant boost in discharge capacity even with Mg-rich Li—Mg alloy in the dual-phase alloy.

### Example 2

### Rate Capability Tests Of Lithium-Sulfur Symmetric Cells Including a Including a Freestanding Composite Anode Including a Li—Mg Alloy and LTO

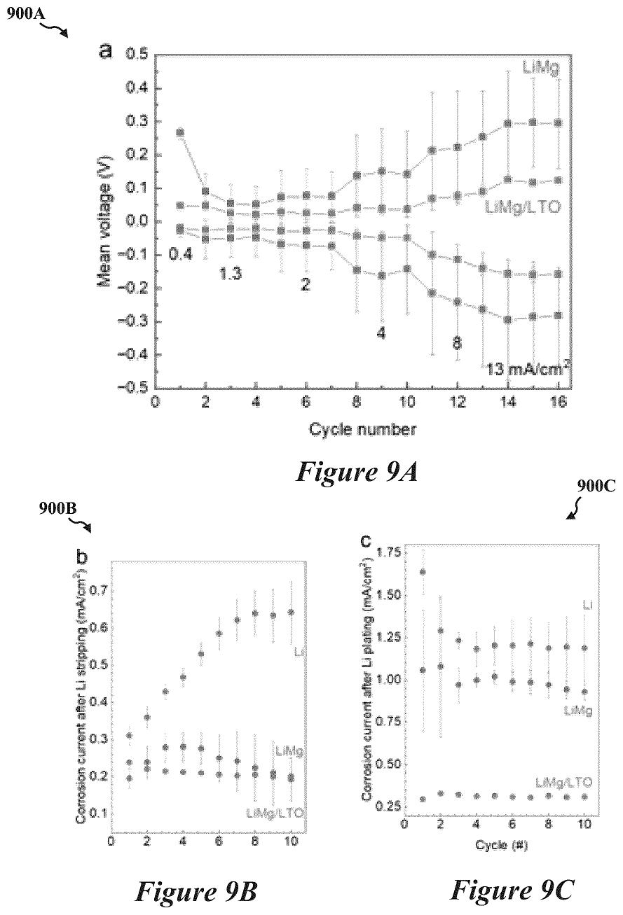

FIG. 9A shows a plot 900A illustrating the rate capability test performance of lithium-sulfur symmetric cells including a freestanding composite anode including a Li—Mg alloy and LTO, according to some implementations. The rate capability test in the symmetric cells were conducted at real current densities from 0.4 mA/cm² to 13 mA/cm². In the symmetric cells, Li—Mg or Li—Mg/LTO electrodes were separated by a Celgard PP2075 separator. Rate capability tests may be used to monitor voltage loss at increasing current densities. Negligible voltage loss or polarization suggests that the cell is capable of high discharge capacities. As can be seen from FIG. 9A, the cells with Li—Mg/LTO composite anodes show negligible voltage loss across current densities from 0.4 mA/cm² to 13 mA/cm² compared to cells with Li—Mg alloy anodes. At a current density of 13 mA/cm², the symmetric cells the Li—Mg/LTO composite anodes showed a voltage loss of only approximately 0.12 V, which is approximately a third of the overpotential of approximately 0.3V measured using the symmetric cells using Li—Mg anodes.

FIG. 9B shows a plot 900B illustrating corrosion current after lithium stripping measured using lithium-sulfur symmetric cells including a freestanding composite anode including a Li—Mg alloy and LTO, according to some implementations. FIG. 9C shows a plot 900C illustrating corrosion current after lithium plating measured using lithium-sulfur symmetric cells including a freestanding composite anode including a Li—Mg alloy and LTO, according to some implementations. The corrosion currents after stripping and plating were obtained using Tafel plots (not shown). Referring to FIG. 9B, the corrosion current after stripping in cells with Li—Mg anodes and Li—Mg/LTO composite anode is not significantly different. Additionally, the significantly higher corrosion current associated with cells including lithium-metal anodes indicate that cells with Li—Mg anodes may result in better cyclic stability compared to cells with lithium-metal anodes.

Referring to FIG. 9C, the corrosion current after lithium plating suggests that the low reactivity of the Li—Mg/LTO composite anode may be a promising candidate for increasing the cyclic stability in lithium-sulfur batteries. As previously discussed with reference to FIG. 9A, the cells with Li—Mg/LTO composite anodes also showed negligible voltage loss across current densities from 0.4 mA/cm² to 13 mA/cm² indicative of high discharge capacities.

### Example 3

### Cathode Discharge Capacity of Lithium-Sulfur Coin Cells Including a Freestanding Li—Mg/LTO Composite Anode at C/3 Discharge Rate

FIG. 10 shows a plot 1000 illustrating cathode discharge capacity of lithium-sulfur coin cells including a freestanding Li—Mg/LTO composite anode including a Li—Mg alloy and LTO, according to some implementations.

Cathode discharge capacity at C/3 rate of example lithium-sulfur coin cells with Li—Mg/LTO composite anodes was compared with cells including 72 Li-28 Mg alloy anode (72 wt % lithium, 28 wt % magnesium) and cells with 90 Li-10 Mg alloy (90 wt % lithium, 10 wt % magnesium) alloy anode. Two Li—Mg/LTO composite anode compositions were evaluated: 72 Li-28 Mg/LTO and 90 Li-10 Mg/LTO. The anode thickness in each case was approximately 100 μm. Formation cycles included 2 discharge/charge cycles at C/20 rate and 1 cycle at C/10 rate. The cathode loading was approximately 7.5 mg/cm². The cathode capacity in each case was approximately 4 mAh/cm2. A Celgard PP2075 separator was used between the cathode and anode. The anode did not include any polymeric material coating. The E/S ratio was approximately 5. The anode did not include any polymeric material coating.

Referring to FIG. 10, the cells with 72 Li-28 Mg/LTO composite anodes were characterized by higher reactivity and improved cycling through approximately 200 cycles compared to the performance of the 72 Li-28 Mg alloy anode. The cells with 72 Li-28 Mg/LTO composite anodes also had better cyclic stability than the cells with the 90 Li-10 Mg/LTO anodes indicating that the addition of LTO resulted in improving cyclic stability at high discharge capacities of approximately 600 mAh/g and confirm the observations associated with FIGS. 9A-9C. Optimizing the Li—Mg composition (for example, increasing Mg content) and screening of lithium-ion conductive materials may further improve the cyclic stability of lithium-sulfur batteries without sacrificing discharge capacity.

### Example 4

### Cathode Discharge Capacity and Capacity Retention of Lithium-Sulfur Coin Cells Including a Freestanding Li—Al—Mg Ternary Alloy Anode

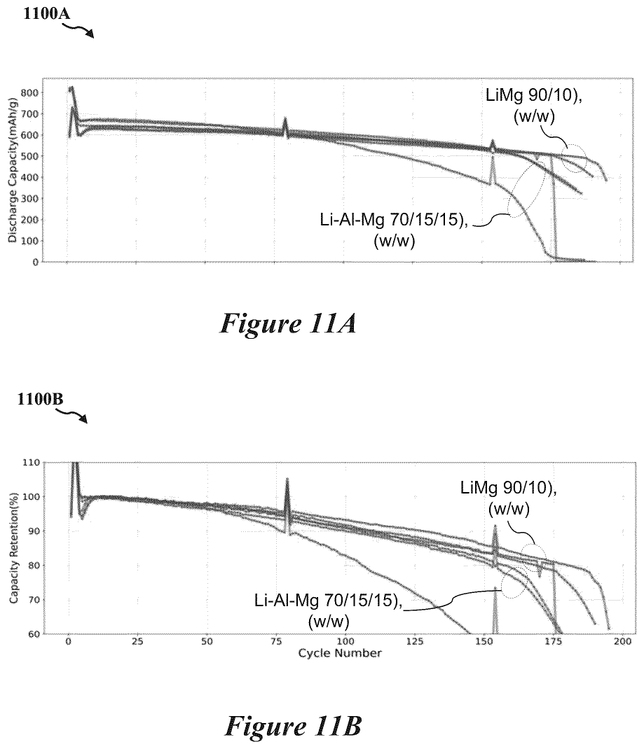

FIG. 11A-11B show plots 1100A-1100B illustrating cathode discharge capacity and capacity retention of lithium-sulfur coin cells including a freestanding Li—Al—Mg ternary alloy anode, according to some implementations. The aluminum content in the example Li—Al—Mg ternary alloy anode was approximately 15 wt %. The magnesium content in the example Li—Al—Mg ternary alloy anode was approximately 15wt %. Accordingly, the lithium content in the example Li—Al—Mg alloy anode was approximately 70 wt %.

Cathode discharge capacity and capacity retention at C/3 rate of the example lithium-sulfur coin cells with freestanding Li—Al—Mg ternary alloy anodes were compared with cells including a freestanding 90 wt % Li-10 wt % Mg alloy anode. The cathode loading was approximately 7 mg/cm². A Celgard PP2075 separator was disposed between the cathode and anode. The E/S ratio was approximately 5 ml/g sulfur. The N/P ratio was between approximately 2.4 and approximately 2.6.

Referring to FIGS. 11A-11B, cathode discharge capacity and capacity retention associated with the lithium-sulfur cells with the freestanding Li—Al—Mg ternary alloy anode was comparable to that of the cells including the reference freestanding 90 wt % Li-10 wt % Mg alloy anode. At approximately 80% capacity retention, the discharge capacity was greater than approximately 500 mAh/g through approximately 150 cycles. Accordingly, the lithium content in freestanding Li—Mg alloys may be reduced to approximately 70 wt % by including a ternary alloying element including aluminum. Additionally, undesirable prolonged activation was not observed during testing of lithium-sulfur coin cells including Li—Al—Mg alloys with a lithium content of approximately 70 wt %.

### Example 5

### Cathode Discharge Capacity and Capacity Retention of Lithium-Sulfur Coin Cells Including a Freestanding Li—Si—Mg Ternary Alloy Anode

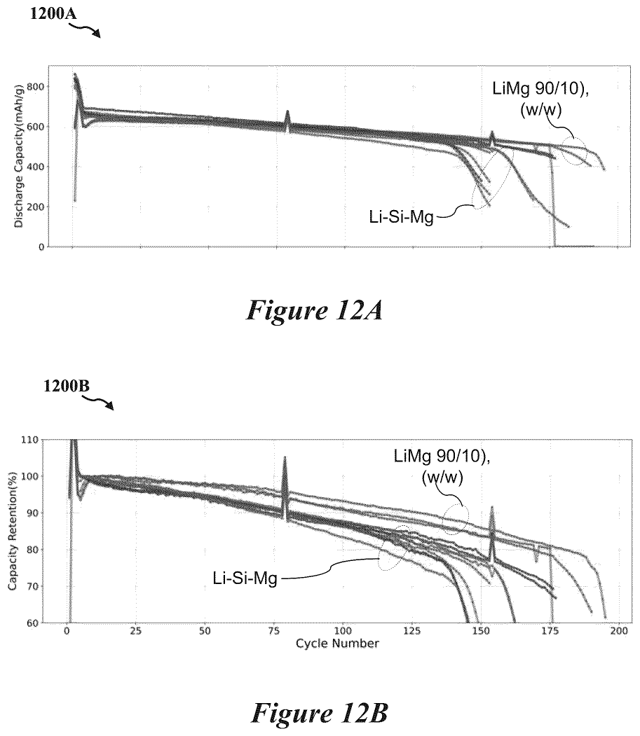

FIG. 12A-12B show plots 1200A-1200B illustrating cathode discharge capacity and capacity retention of lithium-sulfur coin cells including a freestanding Li—Si—Mg ternary alloy anode, according to some implementations. The silicon content in the example Li—Si—Mg ternary anode was approximately 20 wt %. The magnesium content in the example Li—Al—Mg ternary alloy anode was between approximately 15 wt % and approximately 25 wt %. Accordingly, the lithium content in the example Li—Si—Mg ternary alloy anode was between approximately 55 wt % and approximately 65 wt %.

Cathode discharge capacity and capacity retention at C/3 rate of the example lithium-sulfur coin cells with freestanding Li—Si—Mg ternary alloy anodes was compared with cells including a freestanding 90 wt % Li— 10 wt % Mg alloy anode. The cathode loading was approximately 7 mg/cm². A Celgard PP2075 separator was disposed between the cathode and anode. The E/S ratio was approximately 5 ml/g sulfur. The N/P ratio was approximately 2.4.

Referring to FIGS. 12A-12B, cathode discharge capacity associated with of the lithium-sulfur cells with the freestanding Li—Si—Mg ternary alloy anode was comparable to that of the cells including the reference freestanding 90 wt % Li— 10 wt % Mg ternary alloy anode. At approximately 80% capacity retention, the discharge capacity was greater than approximately 500 mAh/g. However, the cells including the reference freestanding 90 wt % Li— 10 wt % Mg alloy anode were relatively more stable through approximately 175 cycles. Accordingly, the lithium content in freestanding Li—Mg alloys may be reduced to between approximately 55 wt % and approximately 65 wt % by including a ternary alloying element including silicon. Additionally, undesirable prolonged activation was not observed during testing of lithium-sulfur coin cells including Li—Si—Mg alloys.

### Example 6

### Cathode Discharge Capacity, Capacity Retention, and Polarization of Lithium-Sulfur Coin Cells Including a Freestanding Li—Mg/C Alloy Anode

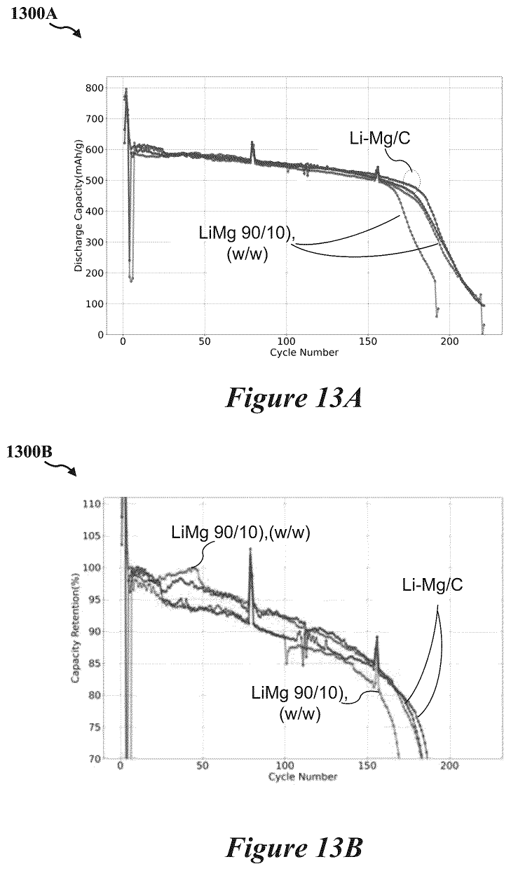

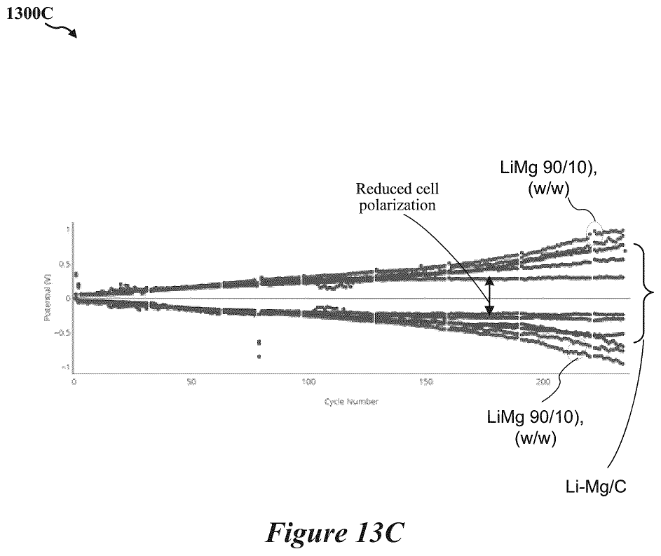

FIG. 13A-13C show plots 1300A-1300C illustrating cathode discharge capacity, capacity retention, and polarization of lithium-sulfur coin cells including a freestanding Li—Mg/C alloy anode, according to some implementations. Graphite was used as the representative carbon material. The graphite content in the example Li—Mg/C anode was approximately 13 wt %.

Cathode discharge capacity and capacity retention at C/3 rate of the example lithium-sulfur coin cells with freestanding Li—Mg/C alloy anodes was compared with cells including a freestanding 90 wt % Li— 10 wt % Mg alloy anode. The cathode loading was approximately 7.4 mg/cm². A Celgard PP2075 separator was disposed between the cathode and anode. The E/S ratio was approximately 5 ml/g sulfur. The N/P ratio was approximately 3.5.

Referring to FIGS. 13A-13B, cathode discharge capacity associated with of the lithium-sulfur cells including the freestanding Li—Mg/C alloy anode was comparable to that of the cells including the reference freestanding 90 wt % Li— 10 wt % Mg alloy anode. At approximately 80% capacity retention, the discharge capacity was approximately 400 mAh/g. Additionally, undesirable prolonged activation was not observed during testing of lithium-sulfur coin cells including Li—Mg/C alloys. Referring to FIG. 13C, a reduction in cell polarization was observed at 1C rate with the cells including the Li—Mg/C alloy anode, which suggests that the addition of carbon in a Li—Mg alloy decreases the overpotential and mitigates the loss in energy density upon cycling and improves the electrochemical performance of lithium-sulfur batteries.

### Example 7

### Cathode Discharge Capacity of Lithium-Sulfur Coin Cells Including Lithium-Magnesium Alloy Composite Anodes

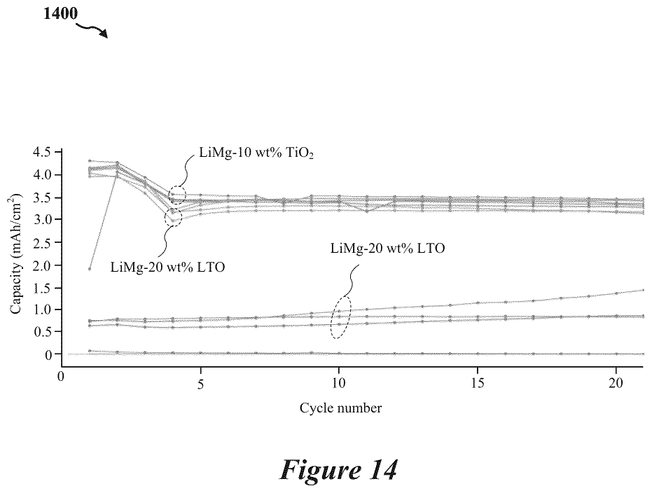

FIG. 14 shows a plot 1400 illustrating early cycling cathode discharge capacity of lithium-sulfur coin cells including lithium-magnesium alloy composite anodes, according to some implementations. The example lithium-magnesium alloy composite anodes included approximately 10 wt % to approximately 20 wt % LTO or approximately 10 wt % titanium oxide (TiO₂). Specifically, the composition of the example anodes including approximately 10 wt % LTO was approximately 69.3 wt % Li, approximately 20.7 wt % Mg, and approximately 10 wt % LTO. The composition of the example anodes including approximately 20 wt % LTO was approximately 61.6 wt % Li, approximately 18.4 wt % Mg, and approximately 20 wt % LTO. The composition of the example anodes including approximately 10 wt % TiO₂ was approximately 69.3 wt % Li, approximately 20.7 wt % Mg, and approximately 10 wt % TiO₂. An average particle size (d₅₀) of TiO₂ nanoparticles was between approximately 10 nm and approximately 50 nm. An average particle size (d₅₀) of LTO was between approximately 0.9 μm and approximately 1.8 μm.

Cathode discharge capacity at C/3 rate of lithium-sulfur coin cells was measured. The electrolyte included a liquid fluorinated ether electrolyte with an approximate composition of 50:25:25 (vol %) 1,2-dimethoxyethane (DME): 1,3-dioxolane (DOL): bis (2,2,2-trifluoroethyl) ether (BTFE), and including approximately 0.4 M LiTFSI and approximately 2 wt % LiNO₃.

Referring to FIGS. 14, cathode discharge capacity during early cycling associated with the lithium-sulfur cells including composite anodes having approximately 10 wt % nanosized TiO₂ was approximately 3.5 mAh/cm², which is comparable to the cathode discharge capacity associated with the lithium-sulfur cells including composite anodes including approximately 20 wt % LTO. In contrast, lithium-sulfur cells including composite anodes having approximately 10 wt % LTO were characterized by significantly lower discharge capacity, which suggests that these cells failed to be activated. Accordingly, lithium-sulfur cells including anodes including nanosized TiO₂ may be characterized by high discharge capacity without incurring a penalty normally expected in specific capacity (mAh/g) or specific energy (Wh/kg).

### Example 8

### Performance of Lithium-Sulfur Pouch Cells Including Lithium-Magnesium Alloy Composite Anodes

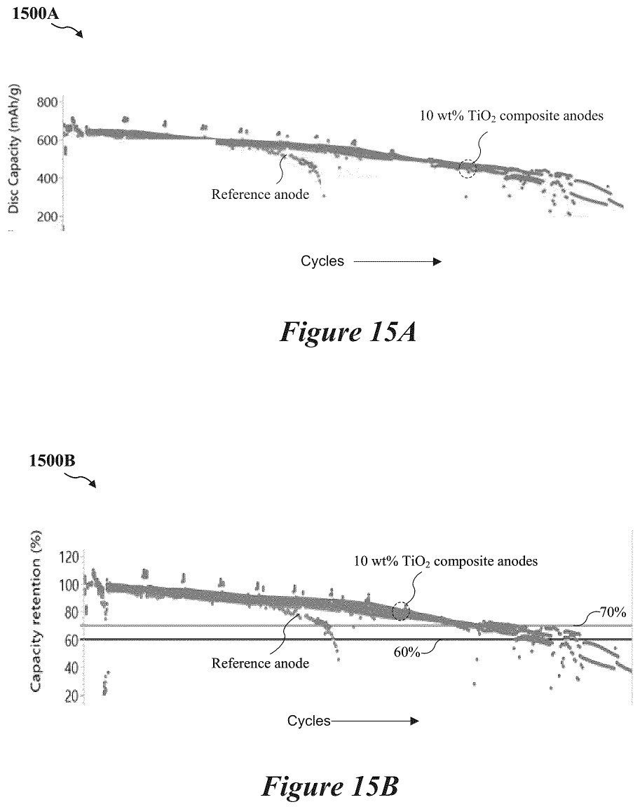

FIGS. 15A-15B show plots 1500A-1500B illustrating discharge capacity and capacity retention, respectively, of lithium-sulfur pouch cells including lithium-magnesium alloy composite anodes, according to some implementations. The composition of the example composite anodes including approximately 10 wt % TiO₂ was approximately 69.3 wt % Li, approximately 20.7 wt % Mg, and approximately 10 wt % TiO₂ (referred to herein as the “10 wt % TiO₂ composite anodes”). Cathode discharge capacity and capacity retention were measured at C/3 charge/discharge rate. For comparison, the performance of lithium-sulfur pouch cells including 90 wt % Li— 10 wt % Mg alloy anodes not including lithium-ion conducting materials or ionic fillers (referred to herein as the “reference anodes”) is also shown FIGS. 15A-15B. The N/P ratio was approximately 2.8.

The E/S ratio was approximately 3.7 ml/g sulfur. The electrolyte included a liquid fluorinated ether electrolyte with an approximate composition of 50:25:25 (vol %) 1,2-dimethoxyethane (“DME”): 1,3-dioxolane (“DOL”): bis (2,2,2-trifluoroethyl) ether (“BTFE”) and including approximately 0.6 M LiTFSI, approximately 0.5M (molar) LiNO₃, and approximately 0.15M dicyandiamide (“DCDA”).

Referring to FIGS. 15A-15B, the cathode discharge capacity associated with the lithium-sulfur pouch cells including the 10 wt % TiO₂ composite anodes was at least 500 Wh/kg at approximately 70% capacity retention. In contrast, the cathode discharge capacity associated with the lithium-sulfur pouch cells including the reference anodes dipped below 500 Wh/kg at approximately 70% capacity retention significantly earlier during the cycling tests, which suggests that composite anodes including TiO₂ improve the electrochemical performance of lithium-sulfur cells.

As previously described herein, in a freestanding Li-metal anode associated with a lithium-ion battery including a lithium-sulfur battery, the anode is not supported on a metal substrate such as a copper current collector. In some implementations, any one of the composite anodes or ternary alloy anodes described herein may also be configured as supported anodes and may be disposed on one or more of a carbon support or a metal substrate. For the sake of clarity, composite anode compositions disposed on a support may include a Li—Mg alloy and one or more of a lithium-ion conducting material, an electron conducting material, or an ionic filler.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c. Unless otherwise specified in this disclosure, for construing the scope of the term “about” or “approximately,” the error bounds associated with the values (dimensions, operating conditions etc.) disclosed is ±10% of the values indicated in this disclosure. The error bounds associated with the values disclosed as percentages is ±1% of the percentages indicated. The word “substantially” used before a specific word includes the meanings “considerable in extent to that which is specified,” and “largely but not wholly that which is specified.”

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations can also be implemented in combination in a single implementation. Conversely, various features that are described in the context of a single implementation can also be implemented in multiple implementations separately or in any suitable subcombination. As such, although features may be described above in combination with one another, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

What is claimed is:

1. A freestanding composite anode associated with a lithium-sulfur battery, the freestanding composite anode including a lithium-magnesium (Li—Mg) alloy and one or more of a lithium-ion conducting material, an electron conducting material, or an ionic filler.

2. The freestanding composite anode of claim 1, wherein the lithium-ion conducting material includes one or more of lithium titanate (LTO), lithium lanthanum zirconium oxide (LLZO), lithium nitride (Li₃N), or lithium phosphide (Li₃P).

3. The freestanding composite anode of claim 1, wherein the ionic filler includes one or more of alumina (Al₂O₃) or titanium dioxide (TiO₂).

4. The freestanding composite anode of claim 1, wherein an average particle size of the ionic filler is less than 50 nm.

5. The freestanding composite anode of claim 1, wherein an average particle size of the lithium ion conducting material is between approximately 0.5 μm and approximately 2 μm.

6. The freestanding composite anode of claim 1, wherein an amount of the lithium-ion conducting material is between approximately 10 wt % and approximately 40 wt %.

7. The freestanding composite anode of claim 1, wherein an amount of the ionic filler is between approximately 10 wt % and approximately 40 wt %.

8. The freestanding composite anode of claim 1, wherein the Li—Mg alloy includes a 90 wt % Li— 10 wt % Mg alloy.

9. The freestanding composite anode of claim 1, further including a polymer coating including one or more of polyvinylidene fluoride (PVDF), pentaerythritol tetraacrylate (PETEA), or polyethylene glycol dimethacrylate (PEGDMA) disposed on the freestanding composite anode.

10. The freestanding composite anode of claim 1, wherein a magnesium content in the Li—Mg alloy is between approximately 10 wt % and approximately 28 wt %.

11. The freestanding composite anode of claim 1, wherein the electron conducting material includes one or more of carbon, aluminum, or silicon.

12. The freestanding composite anode of claim 11, wherein the carbon includes one or more of graphite, carbon nanotubes (CNT), carbon nano onions (CNOs), carbon nanofibers, or fullerenes.

13. The freestanding anode of claim 11, wherein a carbon content of the freestanding anode is between approximately 1 wt % and approximately 20 wt %.

14. A freestanding anode associated with a lithium-sulfur battery, the freestanding anode including a lithium-X-magnesium (Li—X—Mg) ternary alloy, wherein X is a component that includes one or more of aluminum or silicon.

15. The freestanding anode of claim 14, wherein an amount of the component X in the Li-X-Mg ternary alloy is between approximately 5 wt % and approximately 20 wt %.

16. The freestanding anode of claim 14, further including one or more of a lithium-ion conducting material, an electron conducting material, or an ionic filler.

17. A lithium-sulfur battery including:
a freestanding composite anode including a lithium-magnesium (Li—Mg) alloy and one or more of a lithium-ion conducting material, an electron conducting material, or an ionic filler; and
a fluorinated ether electrolyte.

18. The lithium-sulfur battery of claim 17, wherein the fluorinated ether electrolyte includes one or more of:
approximately 50:25:25 (vol %) 1,2-dimethoxyethane (DME): 1,3-dioxolane (DOL): bis (2,2,2-trifluoroethyl) ether (BTFE) and including approximately 0.4 M LiTFSI and approximately 2 wt % LiNO₃;
approximately 50:25:25 (vol %) DME: DOL: 1,1,2,2-tetraethoxyethane (TEE) and including approximately 0.4 M LiTFSI and approximately 2 wt % LiNO₃;
approximately 50:25:25 (vol %) DME: DOL: 1,1,2,2-tetrafluoroethyl 2,2,2-trifluoroethyl ether (TFETFE) and including approximately 0.4 M LiTFSI and approximately 2 wt % LiNO₃;
approximately 60:20:10:10 (vol %) DME: DOL: TEE: TFETFE and including approximately 0.4 M LiTFSI and approximately 2 wt % LiNO₃;
approximately 50:25:25 (vol %) DME: DOL: 1,1,2,2-tetrafluoroethyl-2,2,3,3-tetrafluoropropyl ether (TTE) and including approximately 0.4M LiTFSI and approximately 2 wt % LiNO₃;
approximately 50:25:25 (vol %) 1,2-dimethoxyethane (DME): 1,3-dioxolane (DOL): bis (2,2,2-trifluoroethyl) ether (BTFE), and including between approximately 0.6 M and approximately 0.8M LiTFSI, between approximately 0.5M and approximately 0.7M LiNO₃, and between approximately 0.15M and approximately 0.2M dicyandiamide (DCDA).
approximately 50:25:25 (vol %) DME: DOL: 1 fluorinated 1,4-dimethoxylbutane (FDMB) including approximately 0.4 M LiTFSI and approximately 2 wt % LiNO₃; or
approximately 1.0 M LiTFSI in approximately 50:50 (vol %) DOL: BTFE.

19. The lithium-sulfur battery of claim 17, further including a polymer coating disposed on the freestanding composite anode.

20. The lithium-sulfur battery of claim 19, wherein the polymer coating includes one or more of polyvinylidene fluoride (PVDF), pentaerythritol tetraacrylate (PETEA), or polyethylene glycol dimethacrylate (PEGDMA).

21. The lithium-sulfur battery of claim 19, wherein a thickness of the polymer coating is between approximately 1 μm and approximately 10 μm.
